(19) United States
(12) Patent Application Publication
(10) Pub. No.: US 2011/0149018 A1
(43) Pub. Date: Jun. 23, 2011

(54) HOLOGRAPHIC DISPLAY DEVICE COMPRISING MAGNETO-OPTICAL SPATIAL LIGHT MODULATOR

(75) Inventors: Bo Kroll, London (GB); Norbert Leister, Dresden (DE); Armin Schwerdtner, Dresden (DE); Ralf Haussler, Dresden (DE)

(73) Assignee: SeeReal Technologies S.A., Munsbach (LU)

(21) Appl. No.: 12/447,149

(22) PCT Filed: Oct. 26, 2007
(86) PCT No.: PCT/EP2007/061532

§ 371 Date: Dec. 3, 2010

(30) Foreign Application Priority Data
Oct. 26, 2006 (GB) 0621360.7
Dec. 22, 2006 (GB) 0625838.8
Mar. 21, 2007 (GB) 0705398.6
Mar. 21, 2007 (GB) 0705399.4
Mar. 21, 2007 (GB) 0705401.8
Mar. 21, 2007 (GB) 0705402.6
Mar. 21, 2007 (GB) 0705403.4
Mar. 21, 2007 (GB) 0705404.2
Mar. 21, 2007 (GB) 0705405.9
Mar. 21, 2007 (GB) 0705406.7
Mar. 21, 2007 (GB) 0705407.5
Mar. 21, 2007 (GB) 0705408.3
Mar. 21, 2007 (GB) 0705409.1
Mar. 21, 2007 (GB) 0705410.9
Mar. 21, 2007 (GB) 0705411.7
Mar. 21, 2007 (GB) 0705412.5
May 16, 2007 (GB) 0709376.8
May 16, 2007 (GB) 0709379.2
May 21, 2007 (DE) 102007024236.2
May 21, 2007 (DE) 102007024237.0
Jul. 23, 2007 (GB) 0714272.2

(51) Int. Cl. H04N 5/89; H01J 9/00

(52) U.S. Cl. 348/40; 445/24

(57) ABSTRACT

A holographic display device comprising at least one magneto-optical spatial light modulator (MOSLM). The holographic display device may comprise a first MOSLM and a second MOSLM, the first and second MOSLMs encoding a hologram and a holographic reconstruction being generated by the device. An advantage of the device is fast encoding of holograms.

### BACKGROUND OF THE INVENTION

1. Field of the Invention

The invention relates to a holographic display device on which computer-generated video holograms (CGHs) are encoded, the display comprising at least one magneto-optical SLM. The display generates three dimensional holographic reconstructions.

2. Technical Background

Computer-generated video holograms (CGHs) are encoded in one or more spatial light modulators (SLMs); the SLMs include controllable cells. The cells modulate the amplitude and/or phase of light by encoding hologram values corresponding to a video-hologram. The CGH may be calculated e.g. by coherent ray tracing, by simulating the interference between light reflected by the scene and a reference wave, or by Fourier or Fresnel transforms. An ideal SLM would be capable of representing arbitrary complex-valued numbers, i.e. of separately controlling the amplitude and the phase of an incoming light wave. However, a typical SLM controls only one property, either amplitude or phase, with the undesirable side effect of also affecting the other property. Different ways to modulate the light in amplitude or phase are known, e.g. electrically addressed liquid crystal SLM, optically addressed liquid crystal SLM, micro mirror devices or acousto-optic modulators. The modulation of the light may be spatially continuous or composed of individually addressable cells, one-dimensionally or two-dimensionally arranged, binary, multi-level or continuous. One type of known SLM is a magneto-optical SLM (MOSLM). In a MOSLM, the flow of electric currents in coils on the display control a magnetic field which in turn influences the polarization state of the polarized light propagating through the pixels of the display. A MOSLM is therefore a type of electrically addressable SLM.

In the present document, the term “encoding” denotes the way in which regions of a spatial light modulator are supplied with control values to encode a hologram so that a 3D-scene can be reconstructed from the SLM. By “SLM encoding a hologram” it is meant that a hologram is encoded on the SLM.

In contrast to purely auto-stereoscopic displays, with video holograms an observer sees an optical reconstruction of a light wave front of a three-dimensional scene. The 3D-scene is reconstructed in a space that stretches between the eyes of an observer and the spatial light modulator (SLM), or possibly even behind the SLM. The SLM can also be encoded with video holograms such that the observer sees objects of a reconstructed three-dimensional scene in front of the SLM and other objects at or behind the SLM.

The cells of the spatial light modulator are preferably transmissive cells which are passed through by light, the rays of which are capable of generating interference at least at a defined position and over a coherence length of a few millimetres or more. This allows holographic reconstruction with an adequate resolution in at least one dimension. This kind of light will be referred to as ‘sufficiently coherent light’.

In order to ensure sufficient temporal coherence, the spectrum of the light emitted by the light source must be limited to an adequately narrow wavelength range, i.e. it must be near-monochromatic. The spectral bandwidth of high-brightness LEDs is sufficiently narrow to ensure temporal coherence for holographic reconstruction. The diffraction angle at the SLM is proportional to the wavelength, which means that only a monochromatic source will lead to a sharp reconstruction of object points. A broadened spectrum will lead to broadened object points and smeared object reconstructions. The spectrum of a laser source can be regarded as monochromatic. The spectral line width of a single-colour LED is sufficiently narrow to facilitate good reconstructions.

Spatial coherence relates to the lateral extent of the light source. Conventional light sources, like LEDs or Cold Cathode Fluorescent Lamps (CCFLs), can also meet these requirements if they radiate light through an adequately narrow aperture. Light from a laser source can be regarded as emanating from a point source within diffraction limits and, depending on the modal purity, leads to a sharp reconstruction of the object, i.e. each object point is reconstructed as a point within diffraction limits.

Light from a spatially incoherent source is laterally extended and causes a smearing of the reconstructed object. The amount of smearing is given by the broadened size of an object point reconstructed at a given position. In order to use a spatially incoherent source for hologram reconstruction, a trade-off has to be found between brightness and limiting the lateral extent of the source with an aperture. The smaller the light source, the better is its spatial coherence.

A line light source can be considered to be a point light source if seen from a right angle to its longitudinal extension. Light waves can thus propagate coherently in that direction, but incoherently in all other directions.

In general, a hologram reconstructs a scene holographically by coherent superposition of waves in the horizontal and the vertical directions. Such a video hologram is called a full-parallax hologram. The reconstructed object can be viewed with motion parallax in the horizontal and the vertical directions, like a real object. However, a large viewing angle requires high resolution in both the horizontal and the vertical direction of the SLM.

Often, the requirements on the SLM are lessened by restriction to a horizontal-parallax-only (HPO) hologram. The holographic reconstruction takes place only in the horizontal direction, whereas there is no holographic reconstruction in the vertical direction. This results in a reconstructed object with horizontal motion parallax. The perspective view does not change upon vertical motion. A HPO hologram requires less resolution of the SLM in the vertical direction than a full-parallax hologram. A vertical-parallax-only (VPO) hologram is also possible but uncommon. The holographic reconstruction occurs only in the vertical direction and results in a reconstructed object with vertical motion parallax. There is no motion parallax in the horizontal direction. The different perspective views for the left eye and right eye have to be created separately.

3. Discussion of Related Art

WO 2004/044659 (US2006/0055994) filed by the applicant, which is incorporated herein by reference, describes a device for reconstructing three-dimensional scenes by way of diffraction of sufficiently coherent light; the device includes a point light source or line light source, a lens for focusing the light and a spatial light modulator. In contrast to conventional holographic displays, the SLM in transmission mode reconstructs a 3D-scene in at least one ‘virtual observer window’ (see Appendix I and II for a discussion of this term and the related technology). Each virtual observer window is situated near the observer's eyes and is restricted in size so that the virtual observer windows are situated in a single diffraction order, so that each eye sees the complete reconstruction of the three-dimensional scene in a frustum-shaped reconstruction space, which stretches between the SLM surface and the virtual observer window. To allow a holographic reconstruction free of disturbance, the virtual observer window size must not exceed the periodicity interval of one diffraction order of the reconstruction. However, it must be at least large enough to enable a viewer to see the entire reconstruction of the 3D-scene through the window(s). The other eye can see through the same virtual observer window, or is assigned a second virtual observer window, which is accordingly created by a second light source. Here, a visibility region, which would typically be rather large, is limited to the locally positioned virtual observer windows. The known solution reconstructs in a diminutive fashion the large area resulting from a high resolution of a conventional SLM surface, reducing it to the size of the virtual observer windows. This leads to the effect that the diffraction angles, which are small due to geometrical reasons, and the resolution of current generation SLMs are sufficient to achieve a real-time holographic reconstruction using reasonable, consumer level computing equipment.

However, difficulties with the frame rate which can be generated by a holographic display are encountered, especially if more than one viewer of the display is considered. In the hologram-generation approach described in WO 2004/044659 (US2006/0055994), virtual observer windows (VOW) are generated. A reconstructed object can be seen if a VOW is located at an observer's eye. One VOW is needed for each eye of each observer. A high frame rate is required if the VOWs and the colors red (R) green (G) and blue (B) are generated sequentially. “Sequentially” means that light for the colours R, G and B is switched on and off in sequence, and therefore the same SLM cell is used sequentially to encode the R, G and B light for that pixel on the SLM. To avoid the perception of flickering, a frame rate for each eye of at least 30 Hz is necessary. As an example, for 3 observers a frame rate of 30 Hz*2 eyes*3 observers*3 colors=540 Hz is required. This is much faster than the frame rate of liquid crystal (LC)-based-SLMs. Even for a single observer, the implied frame rate of 180 Hz would be at the limits of what can be achieved with existing liquid crystal SLM technology—some display artefacts would occur for fast-changing images. Known fast micro-electromechanical systems (MEMS)-SLM do not provide high-resolution phase modulation. For these technologies, the characteristic switching times are ca. 10 ms for LC and ca. 10 μs for MEMS. Hence known devices have severe difficulty in displaying holographic images to multiple observers with full complex holographic encoding, particularly when the images are in colour. For the case of a single observer, faster frame rates than those obtainable using LC technology would be of benefit, such as in applications with fast-moving action such as in video games, in viewing sporting activities or action films, or in military applications.

An SLM (including the case of a pair of SLMs in series) that permits independent modulation of amplitude and phase is advantageous for application in a holographic display. A complex-valued hologram has better reconstruction quality and higher brightness than a pure amplitude or a pure phase hologram. Prior-art Faraday-effect magneto-optic SLMs (MOSLMs) are known but these only modulate the amplitude of the transmitted light, and have not been used in generating holograms. Such SLMs have been reported by Panorama Labs of Rockefeller Center, 1230 Avenue of the Americas, 7th Floor, New York, N.Y. 10020 USA (www.panoramalabs.com), e.g. in WO2005/076714A2, which is incorporated herein by reference, but other such MOSLMs are also known.

Therefore there is a need for a holographic display device, and for a SLM for a holographic display device, which can accommodate high frame rates, and which can preferably encode phase and amplitude information independently.

### SUMMARY OF THE INVENTION

In a first aspect, a holographic display device is provided comprising at least one magneto-optical SLM.

The holographic display device may comprise a first MOSLM and a second MOSLM, the first and second MOSLMs encoding a hologram and a holographic reconstruction being generated by the device. The holographic display device may be such that the first MOSLM and the second MOSLM modulate amplitudes and phases of an array of hologram pixels in a controlled independent manner. The holographic display device may comprise a compact combination of the first MOSLM and the second MOSLM which can be used to modulate the amplitude and the phase of light in sequence and in a compact way such that a complex number, which consists of an amplitude and a phase, can be encoded in the transmitted light, on a pixel by pixel basis.

The holographic display device may comprise a compact combination of an MOSLM and a compact light source of sufficient coherence, the combination being capable of generating a three dimensional image under suitable illumination conditions.

The holographic display device may comprise a large magnification three dimensional image display device component incorporating a compact combination of one or two MOSLMs, with holographic reconstruction of the object.

The holographic display device may incorporate a compact combination of one or two MOSLMs and which may also be used as a projector.

The holographic display device may have at least one SLM which encodes a hologram and a holographic reconstruction is generated by the device.

The holographic display device may be one in which the device modulates light using the Faraday effect. The holographic display device may be one where the Faraday effect is realized using a magneto-photonic crystal. The holographic display device may be one where the Faraday effect is realized using doped glass fibres. The holographic display device may be one where the Faraday effect is realized using a magneto-optical film.

The holographic display device may be one in which holographic reconstruction is visible through a virtual observer window.

The holographic display device may be one in which virtual observer windows can be tiled using spatial or time multiplexing.

The holographic display device may be one in which the display is operable to time sequentially re-encode a hologram on the hologram-bearing medium for the left and then the right eye of an observer.

The holographic display device may be one in which the display is operable to time sequentially re-encode a hologram on a hologram-bearing medium for the left and then the right eye of each of two or more observers.

The holographic display device may be one in which the display has an element for beam steering, or a beamsplitter.

The holographic display device may be one in which the display has a CIAD layer.

The holographic display device may be one in which the display has eye tracking.

The holographic display device may be one in which the display is illuminated with a backlight and micro-lens array. The micro-lens array may provide localised coherence over a small region of the display, that region being the only part of the display that encodes information used in reconstructing a given point of the reconstructed object. The display may contain a reflective polarizer. The display may contain a prismatic optical film.

The holographic display device may have light emitting diodes as its light sources.

The holographic display device may be a television. The holographic display device may be a monitor. The holographic display device may be portable.

In a further aspect, a method of manufacturing a holographic display device is provided, including the steps of taking a glass substrate and successively printing or otherwise creating the layers for an MOSLM on the substrate.

In a further aspect, a method is provided of generating a holographic reconstruction comprising the step of using the display device described above.

In a further aspect, a holographic display device is provided comprising a magneto-optical SLM, the SLM encoding a hologram and a holographic reconstruction being generated by the device. The holographic display device may be a television. The holographic display device may be a monitor. The holographic display device may be a laptop computer. The holographic display device may be a mobile phone. The holographic display device may be a PDA. The holographic display device may be a digital music player. The holographic display device may modulate light using the Faraday effect. The holographic display device may modulate light using the Faraday effect, where the Faraday effect is realized using a magneto-photonic crystal. The holographic display device may modulates light using the Faraday effect, where the Faraday effect is realized using doped glass fibres. The holographic display device may modulates light using the Faraday effect, where the Faraday effect is realized using a magneto-optical film. The holographic display device may be illuminated with a backlight and micro-lens array. The holographic display device backlight may include at least one reflective polarizer for linearly polarized states of light. The holographic display device backlight may include at least one reflective polarizer for circularly polarized states of light. The holographic display device micro-lens array may provide localised coherence over a small region of the display, that region being the only part of the display that encodes information used in reconstructing a given point of the reconstructed object. The holographic display device SLM may give phase encoding. The holographic display device SLM may give amplitude encoding. The holographic display device holographic reconstruction may be visible through a virtual observer window. The holographic display device virtual observer windows may be tiled using spatial or time multiplexing. The holographic display device may be operable such that only when an observer's eyes are positioned approximately at the image plane of the light source can the holographic reconstruction be seen properly. The holographic display device may be such that the size of the reconstructed three dimensional scene is a function of the size of the hologram-bearing medium and the reconstructed three dimensional scene can be anywhere within a volume defined by the hologram-bearing medium and a virtual observer window through which the reconstructed three dimensional scene must be viewed. The holographic display device may encode a hologram comprising a region with information needed to reconstruct a single point of a three dimensional scene, the point being visible from a defined viewing position, and: the region (a) encodes information for that single point in the reconstructed scene and (b) is the only region in the hologram encoded with information for that point, and (c) is restricted in size to form a portion of the entire hologram, the size being such that multiple reconstructions of that point caused by higher diffraction orders are not visible at the defined viewing position. The holographic display device may be operable to time sequentially re-encode a hologram on the hologram-bearing medium for the left and then the right eye of an observer. The holographic display device may be operable to time sequentially re-encode a hologram on the hologram-bearing medium for the left and then the right eye of each of two or more observers. The holographic display device may be operable such that the holographic reconstruction is the Fresnel transform of the hologram and not the Fourier transform of the hologram. The holographic display device may encode a hologram generated by determining the wavefronts at the approximate observer eye position that would be generated by a real version of an object to be reconstructed. The holographic display device may have a prism element for beam steering. The holographic display device may have a CIAD layer. The holographic display device may have eye tracking.

In a further aspect, a method of generating a holographic reconstruction is provided comprising the step of using a display device as described above.

In a further aspect, a holographic display device is provided comprising a first MOSLM and a second MOSLM, the first and second MOSLMs encoding a hologram and a holographic reconstruction being generated by the device. The holographic display device may be one in which the first and second MOSLM modulate amplitudes and phases of an array of hologram pixels in a controlled independent manner. The holographic display device may be one in which one MOSLM modulates the amplitudes of the array of hologram pixels, and the other MOSLM modulates the phases of the array of hologram pixels. The holographic display device may be one in which one MOSLM modulates a first combination of amplitude and phase of the array of hologram pixels, and the other MOSLM modulates a second, different combination of amplitude and phase of the array of hologram pixels. The holographic display device may be one in which light propagating through the device is first encoded in its phase, and is then encoded in its amplitude. The holographic display device may be a television. The holographic display device may be a monitor. The holographic display device may be a laptop computer. The holographic display device may be a mobile phone. The holographic display device may be a PDA. The holographic display device may be a digital music player. The holographic display device may be one in which each MOSLM modulates light using the Faraday effect. The holographic display device may be one in which the device modulates light using the Faraday effect, where in at least one MOSLM the Faraday effect is realized using a magneto-photonic crystal. The holographic display device may be one in which the device modulates light using the Faraday effect, where in at least one MOSLM the Faraday effect is realized using doped glass fibres. The holographic display device may be one in which the device modulates light using the Faraday effect, where in at least one MOSLM the Faraday effect is realized using a magneto-optical film. The holographic display device may be one in which a separation layer separates one MOSLM from the other MOSLM. The holographic display device may be one in which the separation layer is thin enough to prevent the electromagnetic fields of one MOSLM adversely affecting the performance of the other MOSLM. The holographic display device may be one in which the separation layer also provides mechanical support for at least one MOSLM. The holographic display device may be one in which the separation layer is less than or equal to the order of 10 microns to 100 microns. The holographic display device may be one in which the display device encodes a hologram and enables a holographic reconstruction to be generated. The holographic display device may be one in which the display is illuminated with a backlight and micro-lens array. The holographic display device may be one in which the backlight includes at least one reflective polarizer for linearly polarized states of light. The holographic display device may be one in which the backlight includes at least one reflective polarizer for circularly polarized states of light. The holographic display device may be one in which the micro-lens array provides localised coherence over a small region of the display, that region being the only part of the display that encodes information used in reconstructing a given point of the reconstructed object. The holographic display device may be one in which holographic reconstruction is visible through a virtual observer window. The holographic display device may be one in which virtual observer windows can be tiled using spatial or time multiplexing. The holographic display device may be one in which only when an observer's eyes are positioned approximately at the image plane of the light source can the holographic reconstruction be seen properly. The holographic display device may be one in which the size of the reconstructed three dimensional scene is a function of the size of the hologram-bearing medium and the reconstructed three dimensional scene can be anywhere within a volume defined by the hologram-bearing medium and a virtual observer window through which the reconstructed three dimensional scene must be viewed. The holographic display device may be one in which the display encodes a hologram comprising a region with information needed to reconstruct a single point of a three dimensional scene, the point being visible from a defined viewing position, and: the region (a) encodes information for that single point in the reconstructed scene and (b) is the only region in the hologram encoded with information for that point, and (c) is restricted in size to form a portion of the entire hologram, the size being such that multiple reconstructions of that point caused by higher diffraction orders are not visible at the defined viewing position. The holographic display device may be one in which the display is operable to time sequentially re-encode a hologram on the hologram-bearing medium for the left and then the right eye of an observer. The holographic display device may be one in which the display is operable to time sequentially re-encode a hologram on the hologram-bearing medium for the left and then the right eye of each of two or more observers. The holographic display device may be one in which the display is operable such that the holographic reconstruction is the Fresnel transform of the hologram and not the Fourier transform of the hologram. The holographic display device may be one in which the display encodes a hologram generated by determining the wavefronts at the approximate observer eye position that would be generated by a real version of an object to be reconstructed. The holographic display device may be one in which there is a prism element for beam steering. The holographic display device may be one in with a CIAD layer. The holographic display device may be one with eye tracking.

In a further aspect, a method is provided of manufacturing a holographic display device, including the steps of taking a glass substrate and successively printing or otherwise creating the layers for a first MOSLM and for a second MOSLM on the substrate.

In a further aspect, a method is provided of generating a holographic reconstruction comprising the step of using a display device as described above.

In a further aspect, there is provided a compact combination of an MOSLM and a compact light source of sufficient coherence, the combination being capable of generating a three dimensional image under suitable illumination conditions. The compact combination may be one in which there is no requirement for imaging optics. The compact combination may be one in which the device elements are less than 3 cm in thickness in total. The compact combination may be one in which there are soft apertures for the pixels of the compact combination.

In a further aspect there is provided a compact combination of two MOSLMs which can be used to modulate the amplitude and the phase of light in sequence and in a compact way such that a complex number, which consists of an amplitude and a phase, can be encoded in the transmitted light, on a pixel by pixel basis. The compact combination may be one in which there is no requirement for imaging optics. The compact combination may be one in which the device elements are less than 3 cm in thickness in total. The compact combination may be one in which there are soft apertures for the pixels of the device. The compact combination may be one in which the two MOSLMs are directly joined or glued together, with aligned pixels. The compact combination may be one in which the separation of the two MOSLMs is less than or equal to the order of 10 microns to 100 microns. The compact combination may be one in which the diffraction of light passing from one MOSLM to the other MOSLM is in the Fresnel diffraction regime, not the far-field diffraction regime. The compact combination may be one in which there is a lens array between the two MOSLMs such that each lens images a pixel of the first SLM on to the respective pixel of the second SLM. The compact combination may be one in which the aperture width of the first MOSLM pixels is such that it minimizes pixel cross talk. The compact combination may be one in which the aperture width of the first MOSLM pixels is such that it minimizes pixel cross talk in the Fraunhofer diffraction regime to the pixels of the second MOSLM. The compact combination may be one in which a fibre optic faceplate is used to image the pixels of the first MOSLM onto the pixels of the second MOSLM.

In a further aspect there is provided a large magnification three dimensional image display device component incorporating the compact combination of one or two MOSLMs, with holographic reconstruction of the object. The display device component may include a compact combination of one or two MOSLMs and a compact light source of sufficient coherence. The display device component may include a compact combination of one or two MOSLMs and a compact light source of sufficient coherence such that the combination is capable of generating a three dimensional image. The display device component may includes a compact combination of one or two MOSLMs and a compact light source of sufficient coherence, in which the light source is magnified between 10 and 60 times by the lens array. The display device component may include a compact combination of one or two MOSLMs and a compact light source of sufficient coherence, in which at least one MOSLM is positioned within 30 mm of the light source. The display device component may include a compact combination of one or two MOSLMs and a compact light source of sufficient coherence such that the combination is capable of generating a three dimensional image which is viewable in an VOW. The display device component may be one in which the VOW is limited to one diffraction order of the Fourier spectrum of the information encoded in the SLM. The display VOW may be trackable or non-trackable. The display VOW may be enlarged by tiling of VOWs by spatial or temporal multiplexing. The display device component may includes a compact combination of one or two MOSLMs and a compact light source of sufficient coherence, in which the light sources in the light source array have only partial spatial coherence. There may be a PDA including the device component. There may be a mobile phone including the device component. There may be calculation of the holograms that are encoded on the SLM which is performed in an external encoding unit whereby the display data are then sent to the device component to enable the display of a holographically-generated three dimensional image.

In a further aspect there is provided a method of manufacturing a holographic display device, including the steps of taking a glass substrate and successively printing or otherwise creating the layers for one or two MOSLMs on the substrate, the device comprising a large magnification three dimensional image display device component incorporating the compact combination of one or two MOSLMs, with holographic reconstruction of the object.

In a further aspect there is provided a method of generating a holographic reconstruction comprising the step of using a display device component as described above.

By “SLM encoding a hologram” it is meant that a hologram is encoded on the SLM.

### BRIEF DESCRIPTION OF THE DRAWINGS

FIG. 1 is a diagram of a holographic display device including a single MOSLM.

FIG. 2 is a diagram of a holographic display device including a pair of components, where each component contains a single MOSLM.

FIG. 3 is a diagram of part of a MOSLM pixel element according to the prior art.

FIG. 4 is a diagram of a holographic display according to the prior art

FIG. 5 is a cross-sectional diagram of three pixels of a particular example of a holographic display device including a pair of components, where each component contains a single MOSLM.

FIG. 6A is a diagram of a holographic display.

FIG. 6B is a diagram of a holographic display which lends itself to achieving compactness.

FIG. 7 is a diagram of a fabrication step used in fabricating a micro-coil array, according to the prior art.

FIG. 8 is a diagram of a fabrication step used in fabricating a micro-coil array, according to the prior art.

FIG. 9 is a diagram of a holographic display device.

FIG. 10 is a diagram of a holographic display device which incorporates two MOSLMs for encoding amplitude and phase in succession.

FIG. 11 is a diagram of a holographic display device including a single MOSLM.

FIG. 12 is a diagram of a specific example of a holographic display according to an implementation.

FIG. 13 is a diagram of a holographic display device which incorporates two MOSLMs for encoding amplitude and phase in succession.

FIG. 14 is diffraction simulation results obtained using MathCad®.

FIG. 15 is diffraction simulation results obtained using MathCad®.

FIG. 16 is diffraction simulation results obtained using MathCad®.

FIG. 17 is an arrangement of two MOSLMS with a lens array layer between, according to an implementation.

FIG. 18 is a diagram of a diffraction process which may occur as light travels from one MOSLM to a second MOSLM.

FIG. 19 is a diagram of an example of a holographic display component according to an implementation.

FIG. 20 is a diagram of a beam steering element.

FIG. 21 is a diagram of a beam steering element.

FIG. 22 is a schematic drawing of a holographic display comprising light sources in a 2D light source array, lenses in a 2D lens array, a SLM and a beamsplitter. The beamsplitter splits the rays leaving the SLM into two bundles each of which illuminates the virtual observer window for the left eye (VOWL) and the virtual observer window for the right eye (VOWR), respectively.

FIG. 23 is a schematic drawing of a holographic display comprising two light sources of a light source array, and two lenses of a lens array, a SLM and a beamsplitter. The beamsplitter splits the rays leaving the SLM into two bundles each of which illuminates the virtual observer window for the left eye (VOWL) and the virtual observer window for the right eye (VOWR), respectively.

FIG. 24 is a cross-sectional diagram of a prismatic beam steering element.

### DETAILED DESCRIPTION

Various implementations will now be described.

A. Holographic Display Device with a Magneto-Optical SLM

This implementation provides a holographic display device with a magneto-optical SLM, the combination being capable of generating a three dimensional image under suitable illumination conditions. The display may be illuminated by multiple light sources or by a single light source. The holographic display may be used in a television, a monitor, a laptop computer, a mobile phone, a PDA, a digital music player, or any other device in which displays are commonly used.

This implementation relates to a SLM for modulation of light, i.e. modulation of amplitude or phase, or a combination of amplitude and phase. Specifically, it relates to a SLM based on modulation of light by the Faraday effect. The SLM may be used in a holographic display.

The Faraday effect can manifest itself as a rotation of linearly polarized light in a medium upon application of a magnetic field in the direction of light propagation. Quantitatively it is described by the equation

α=VLH (1)

where α is angle by which the polarization is rotated, V the Verdet constant, L the length of the medium and H the magnetic field strength. The Faraday effect is caused by the introduction of an anisotropy by the magnetic field. The magnetic field is an axial vector which implies a sensitivity to the handedness of rotation. Therefore, left and right circular polarized light are not degenerate states anymore and hence they experience a different refractive index and experience different phase shifts in the medium. As linearly polarized light is composed of left-handed and right-handed circularly polarized light, a different phase shift of these components results in a rotation of the angle of linear polarization when the circular components are recombined to form linearly polarized light.

Usually, the Verdet constant V is small and hence a significant rotation angle α requires large lengths L or high magnetic fields H. The Faraday effect is significantly increased in a magneto-photonic crystal comprising a stack of magneto-optic layers. This facilitates the use of the Faraday effect in thin structures with small magnetic fields for a SLM. This is described in, for example, in “A Presentation for Investors” by Panorama Labs of Rockefeller Center, 1230 Avenue of the Americas, 7th Floor, New York, N.Y. 10020 USA (www.panoramalabs.com) (the document is incorporated herein by reference), obtained from the internet. The document may be obtainable from the web.archive.org site.

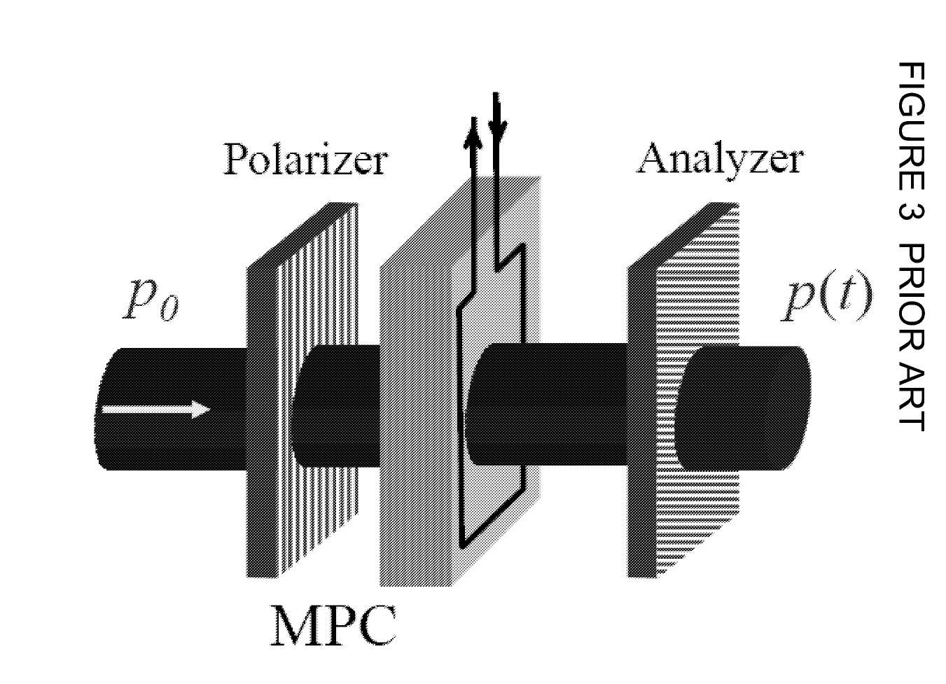

Panorama Labs have reported a SLM that uses the Faraday effect, as shown in FIG. 3. It comprises a magneto-photonic crystal, an input and output polarizer and an array of coils. There is one coil for each pixel of the SLM, with a pixel pitch of 16 μm. The magneto-photonic crystal is composed of a stack of magneto-optic layers which enhance the Faraday effect compared to a single layer. Upon application of an electric current, the coil generates a local magnetic field inside each pixel which causes a rotation of the linear polarization of the light through this pixel. The output polarizer transmits only a specific polarization angle. Hence the transmittance of each pixel can be modulated by the electric current in the coil. FIG. 3 shows one pixel of the SLM with polarizer, magneto-photonic crystal (MPC), coil and analyzer. A constant input intensity p₀ is modulated to give a time (t) dependent output intensity function p(t).

An advantage of a Faraday-effect SLM compared to a LC- or MEMS-SLM is the fast response time. Panorama Labs reported a response time of 20 ns in a Faraday-effect SLM, which is much faster than LC (ca. 10 ms) or MEMS (ca. 10 μs) SLMs. A MOSLM can be used for an electro-holographic display. In one approach for holographic displays, virtual observer windows (VOW) are generated. A reconstructed object can be seen if a VOW is located at an observer's eye. One VOW is needed for each eye of each observer. A high frame rate is required if the VOWs and the colors R, G, B are generated sequentially. To avoid flickering, a frame rate for each eye of at least 30 Hz is necessary. As an example, for 3 observers a frame rate of 30 Hz*2 eyes*3 observers*3 colors=540 Hz is required. This is much faster than the frame rate of LC-SLM. Known fast MEMS-SLM do not provide high-resolution phase modulation. A SLM that modulates amplitude and phase is advantageous for application in an electro-holographic display. A complex-valued hologram has better reconstruction quality and higher brightness than a pure amplitude or a pure phase hologram. The only observable effect for the prior-art Faraday-effect SLM disclosed by Panorama Labs in FIG. 3 is its modulation of the amplitude of the transmitted light. In addition, the prior-art Faraday-effect SLM disclosed by Panorama Labs in FIG. 3 is not illuminated with light of sufficient coherence so as to be able to lead to the generation of a three dimensional image.

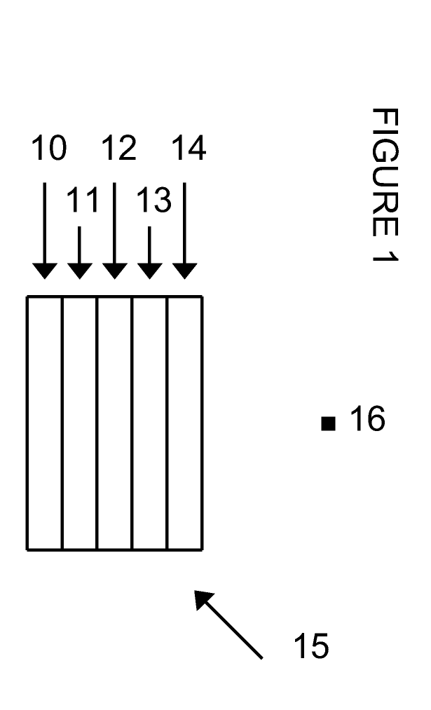

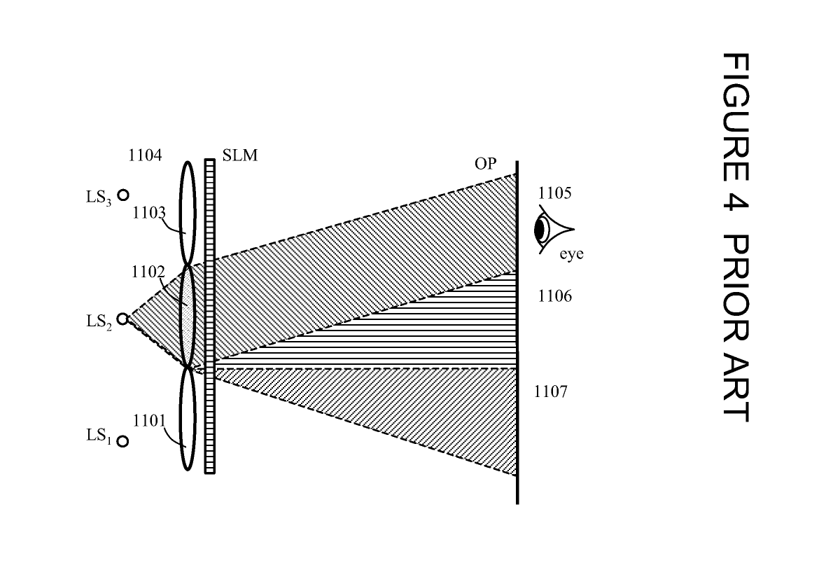

In FIG. 1, an example of an implementation is disclosed. 10 is an illumination apparatus for providing illumination of a plane area, where the illumination has sufficient coherence so as to be able to lead to the generation of a three dimensional image. An example is disclosed in US 2006/250671 for the case of large area video holograms, which is incorporated herein by reference, one example of which is reproduced in FIG. 4. Such an apparatus as 10 may take the form of an array of white light sources, such as cold cathode fluorescent lamps or white-light light emitting diodes which emit light which is incident on a focusing system which may be compact, such as a lenticular array or a microlens array. Alternatively, light sources for 10 may comprise of red, green and blue lasers or red, green and blue light emitting diodes which emit light of sufficient coherence. However, non-laser sources with sufficient spatial coherence (eg. light emitting diodes, OLEDs, cold cathode fluorescent lamps) are preferred to laser sources. Laser sources have disadvantages such as causing laser speckle in the holographic reconstructions, being relatively expensive, and having possible safety problems with regard to possibly damaging the eyes of holographic display viewers or of those who work in assembling the holographic display devices.

Element 10 may include one or two prismatic optical films for increasing display brightness: such films are disclosed eg. in U.S. Pat. No. 5,056,892 and in U.S. Pat. No. 5,919,551, though others are known.

The hologram generator 15 may take on a range of sizes, such as from one cm screen diagonal size (or less) as in a mobile phone sub-display up to one metre screen diagonal (or more) for a large indoor display. Accordingly elements 10-14 may have a total thickness from one millimetre in thickness, or less, in total, up to several tens of centimetres or more in the case of a large indoor display. Element 11 is a polarizing optical element, or a set of polarizing optical elements. One example is a linear polarizer sheet. A further example is a reflective polarizer which transmits one linear polarization state and reflects the orthogonal linear polarization state—such a sheet is described in U.S. Pat. No. 5,828,488, for example, though others are known. A further example is a reflective polarizer which transmits one circular polarization state and reflects the orthogonal circular polarization state—such a sheet is described in U.S. Pat. No. 6,181,395, for example, though others are known. Element 12 may comprise of an array of colour filters, such that pixels of coloured light, such as red, green and blue light, are emitted towards element 13, although the colour filters may not be required if coloured sources of light are used. Element 13 is a magneto-optical SLM. In its simplest form, element 13 is an array of coils of conducting material, each of which is used to control independently the magnetic field experienced by light traversing its corresponding pixel in the display. Such control is facilitated by light passing through a medium with a significant Verdet constant, V, such that linearly polarized light may experience a significant rotation α as it passes through the medium, as described by Eq. (1). The medium may be of the form of doped glass fibre cylinders, or similar shapes, as described in US2005/0201705. The medium may alternatively be of the form of a magneto optical film, as described in WO2005/122479A2, or a magneto-photonic crystal layer. Light exiting the medium is then passed through a light polarizing layer 14, such as a linear polarizer sheet.

If element 11 is a reflective polarizer sheet for circularly polarized states of light, circularly polarized light is transmitted from element 11 towards element 12 while light of the orthogonal polarization is reflected back into element 10 for possible recycling during which its polarization may change to the state which is transmitted by element 11. The polarizer sheet 14 after element 13 consists of a quarter wave plate to convert circular polarization light to linear polarization, followed by a linear polarization sheet, in this example. The quarter wave plate may function over the visible spectrum, as described in U.S. Pat. No. 7,054,049, for example; other quarter wave plates which function over the visible spectrum are known. The linear polarization sheet 14 may be disposed at an azimuthal rotation angle such that when no current flows in the coils of the array, H is zero across the array of pixels, therefore there is no change in polarization state for all pixels of the array, and the display is in the dark state. Other configurations will be obvious to those skilled in the art. Flow of currents in the coils of the array may change the polarization state on a pixel-by-pixel basis, thereby enabling an image, such as a colour image, to be displayed. Where the light input polarization states to the magneto-optical SLM (MOSLM) are pure circular polarization states, the flow of current in the coils enables phases to be encoded on the circular polarization states, as described elsewhere in this document. Such phase-encoding enables a hologram with phase information encoded on it.

If element 11 is a reflective polarizer sheet for linearly polarized states of light, linearly polarized light is transmitted from element 11 towards element 12 while light of the orthogonal polarization is reflected back into element 10 for possible recycling during which its polarization may change to the state which is transmitted by element 11. The polarizer sheet 14 after element 13 is a linear polarization sheet in this example. The linear polarization sheet 14 may be disposed at an azimuthal rotation angle such that when no current flows in the coils of the array, H is zero across the array of pixels, therefore there is no change in polarization state for all pixels of the array, and the display is in the dark state. Other configurations will be obvious to those skilled in the art. Flow of currents in the coils of the array may change the polarization state on a pixel-by-pixel basis, thereby enabling an image, such as a colour image, to be displayed. Where the light input polarization states to the magneto-optical SLM (MOSLM) are pure linear polarization states, the flow of current in the coils enables amplitudes to be encoded on the polarization states, as described elsewhere in this document. Such amplitude-encoding enables a hologram with amplitude information encoded on it.

In FIG. 1, a viewer located at point 16 some distance from the device which includes the hologram generator 15 may view a three dimensional image when viewing in the direction of 15. Elements 10, 11, 12, 13 and 14 may be disposed so as to be in physical, e.g. actual mechanical, contact, each forming a layer of a structure so that the whole is a single, unitary object. Physical contact may be direct. Or it may be indirect, if there is a thin, intervening layer, coating of film between adjacent layers. Physical contact may be limited to small regions that ensure correct mutual alignment or registration, or may extend to larger areas, or the entire surface of a layer. Physical contact may be achieved by layers being bonded together such as through the use of an optically transmitting adhesive, so as to form a hologram generator 15, or by any other suitable process (see also section below titled Outline Manufacturing Process). However, some or all of the elements 10, 11, 12, 13 and 14 may be separate if compactness is not a particular requirement of the device 15.

FIG. 4 is a prior art side view showing three focusing elements 1101, 1102, 1103 of a vertical focusing system 1104 in the form of cylindrical lenses horizontally arranged in an array. The nearly collimated beams of a horizontal line light source LS₂ passing through the focusing element 1102 of an illumination unit and running to an observer plane OP are exemplified. According to FIG. 4, a multitude of line light sources LS₁, LS₂, LS₃ are arranged one above another. Each light source emits light which is sufficiently coherent in the vertical direction and which is incoherent in the horizontal direction. This light passes through the transmissive cells of the light modulator SLM. The light is only diffracted in the vertical direction by cells of the light modulator SLM, which are encoded with a hologram. The focusing element 1102 images a light source LS₂ in the observer plane OP in several diffraction orders, of which only one is useful. The beams emitted by the light source LS₂ are exemplified to pass only through the focusing element 1102 of focusing system 1104. In FIG. 4 the three beams show the first diffraction order 1105, the zeroth order 1106 and the minus first order 1107. In contrast to a single point light source, a line light source allows the production of a significantly higher luminous intensity. Using several holographic regions with already increased efficiency and with the assignment of one line light source for each portion of a 3D-scene to be reconstructed, improves the effective luminous intensity. Another advantage is that, instead of a laser, a multitude of conventional light sources, which are positioned e.g. behind a slot diaphragm, which may also be part of a shutter, generate sufficiently coherent light.

Even though the applicant's preferred approach to holographic encoding, through the use of virtual observer windows, is described in eg. WO 2004/044659 (US2006/0055994) filed by the applicant which describes a device for reconstructing three-dimensional scenes by way of diffraction of sufficiently coherent light, it should be understood that the holographic display of this implementation is not restricted to such an approach, but includes all known holographic display types which may be used together with a MOSLM, as would be obvious to one skilled in the art.

B. Holographic Display Device with Two Magneto-Optical SLMs in Series

This implementation relates to a spatial light modulator (SLM) for complex modulation of light, i.e. independent modulation of amplitude and phase. Specifically, it relates to a SLM based on modulation of light by the Faraday effect. The SLM may be used in a holographic display. The holographic display may be used in a television, a monitor, a laptop computer, a mobile phone, a PDA, a digital music player, or any other device in which displays are commonly used.

This implementation provides a holographic display device with two magneto-optical SLMs in series, the combination being capable of generating a three dimensional image under suitable illumination conditions. The display may be illuminated by multiple light sources or by a single light source.

This implementation relates to two MOSLMs for modulation of light, where each MOSLM modulates amplitude, phase, or a combination of amplitude and phase. Specifically, each MOSLM modulates light using the Faraday effect. The two MOSLMs in combination may be used in a holographic display. Thus, a complex number, which consists of an amplitude and a phase, can be encoded in the transmitted light, on a pixel by pixel basis.

A holographic display device consisting of one or multiple light sources and two MOSLMs in series can be used to modulate the amplitude and the phase of light in sequence and also in a compact way if required. This example of this implementation comprises a first MOSLM and a second MOSLM. The first MOSLM modulates the amplitude of transmitted light and the second MOSLM modulates the phase of the transmitted light. Alternatively, the first MOSLM modulates the phase of transmitted light and the second MOSLM modulates the amplitude of the transmitted light. Alternatively, each MOSLM modulates a combination of amplitude and phase such that the two MOSLMs in combination facilitate full complex modulation. Each MOSLM may be as described in section A above. An overall assembly may be as described in the section A, except two MOSLMs are used here.

In a first step the pattern for phase modulation is written in the first MOSLM. In a second step the pattern for amplitude modulation is written in the second MOSLM. The light transmitted by the second MOSLM has been modulated in its amplitude and in its phase as a result of which an observer may observe a three dimensional image when viewing the light emitted by the device in which the two MOSLM are housed.

It will be appreciated by those skilled in the art that the modulation of phase and amplitude facilitates the representation of complex numbers. Therefore, this implementation may be used to generate holograms such that a three dimensional image may be viewed by a viewer.

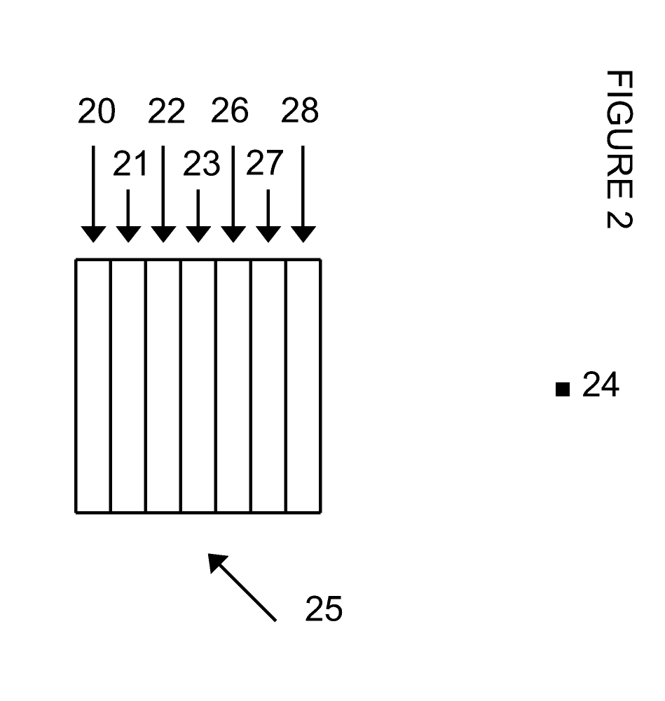

In FIG. 2, an example of this implementation is disclosed. 20 is an illumination apparatus for providing illumination of a plane area, where the illumination has sufficient coherence so as to be able to lead to the generation of a three dimensional image. An example is disclosed in US 2006/250671 for the case of large area video holograms. Such an apparatus as 20 may take the form of an array of white light sources, such as cold cathode fluorescent lamps or white light light emitting diodes which emit light which is incident on a focusing system which may be compact such as a lenticular array or a microlens array. Alternatively, light sources for 20 may comprise of red, green and blue lasers or red, green and blue light emitting diodes which emit light of sufficient coherence. However, non-laser sources with sufficient spatial coherence (eg. light emitting diodes, OLEDs, cold cathode fluorescent lamps) are preferred to laser sources. Laser sources have disadvantages such as causing laser speckle in the holographic reconstructions, being relatively expensive, and having possible safety problems with regard to possibly damaging the eyes of holographic display viewers or of those who work in assembling the holographic display devices.

Element 20 may include one or two prismatic optical films for increasing display brightness: such films are disclosed eg. in U.S. Pat. No. 5,056,892 and in U.S. Pat. No. 5,919,551, though others are known.

The hologram generator 25 may take on a range of sizes, such as from one cm screen diagonal size (or less) as in a mobile phone sub-display up to one metre screen diagonal (or more) for a large indoor display. Accordingly elements 20-23, 26-28 may have a total thickness from one millimetre in thickness, or less, in total, up to several tens of centimetres or more in the case of a large indoor display. Element 21 is a polarizing optical element, or a set of polarizing optical elements. One example is a linear polarizer sheet. A further example is a reflective polarizer which transmits one linear polarization state and reflects the orthogonal linear polarization state—such a sheet is described in U.S. Pat. No. 5,828,488, for example, though others are known. A further example is a reflective polarizer which transmits one circular polarization state and reflects the orthogonal circular polarization state—such a sheet is described in U.S. Pat. No. 6,181,395, for example, though others are known. Element 22 may comprise of an array of colour filters, such that pixels of colour light, such as red, green and blue light, are emitted towards element 23, although the colour filters may not be required if coloured sources of light are used. Element 23 is a MOSLM. In its simplest form, element 23 is an array of coils of conducting material, each of which is used to control independently the magnetic field experienced by light traversing its corresponding pixel in the display. Such control is facilitated by light passing through a medium with a significant Verdet constant, V, such that linearly polarized light may experience a significant rotation α as it passes through the medium, as described by Eq. (1). The medium may be of the form of doped glass fibre cylinders, or similar shapes, as described in US2005/0201705, which is incorporated herein by reference. The medium may alternatively be of the form of a magneto optical film, as described in WO2005/122479A2 which is incorporated herein by reference, or a magneto-photonic crystal.

Element 26 is a polarizing optical element, or a set of polarizing optical elements. Element 27 is a MOSLM, such as is described for element 23 above. Light exiting the MOSLM is then passed through a light polarizing layer 28, such as a linear polarizer sheet. With regard to the transmitted light, element 23 modulates the amplitude and element 27 modulates the phase. Alternatively, element 27 modulates the amplitude and element 23 modulates the phase—this is thought to be preferable as one expects the phase to be modulated more accurately (i.e. with proportionately less noise) while the amplitude is at its maximum value. Close proximity of MOSLMs 23 and 27 enables a reduction in the problems of optical losses and pixel cross-talk arising from optical beam divergence: when MOSLMs 23 and 27 are in closer proximity, a better approximation to non-overlapping propagation of the beams of coloured light through the MOSLMs may be achieved.

A viewer located at point 24 some distance from the device which includes the compact hologram generator 25 may view a three dimensional image when viewing in the direction of 25. Elements 20, 21, 22, 23, 26, 27 and 28 may be arranged so that adjacent elements are in physical, e.g. fixed mechanical, contact, each forming a layer of a structure so that the whole is a single, unitary object. Physical contact may be direct. Or it may be indirect, if there is a thin, intervening layer, coating of film between adjacent layers. Physical contact may be limited to small regions that ensure correct mutual alignment or registration, or may extend to larger areas, or the entire surface of a layer. Physical contact may be achieved by layers being bonded together such as through the use of an optically transmitting adhesive, so as to form a compact hologram generator 25, or by any other suitable process (see also section below titled Outline Manufacturing Process). However, some or all of elements 20, 21, 22, 23, 26, 27 and 28 may be separate if compactness is not a particular requirement.

We give here a simple mathematical treatment of two MOSLMs in series encoding the SLM as a function of the currents in the two coils, for each pixel. More rigorous treatments may be possible. A first Faraday rotator to modulate the phase, a first linear polarizer, a second Faraday rotator to modulate the amplitude and a second linear polarizer are taken into consideration for these calculations, in this sequence.

The first coil has length L₁, current I₁, and N₁ turns. The magnetic field it generates along its axis is therefore H₁=N₁I₁/L₁. The second coil has length L₂, current I₂, and N₂ turns. The magnetic field it generates along its axis is therefore H₂=N₂I₂/L₂. These equations are obtained from “Electromagnetic Fields and Waves” Second Edition by P. Lorrain and D. Corson (W.H. Freeman and Co, San Francisco, USA, 1970) pp. 315-318.

The input light has circular polarization whose complex amplitude can be expressed in Jones calculus as

$${E}_{0} = ( \begin{matrix}1 \\ i\end{matrix} )$$

The Faraday effect in the first rotator shifts the phase of this circular polarization component by

α₁=V₁L₁H₁=V₁N₁I₁

as described by equation (1). The amplitude after the Faraday rotator is

$${E}_{1} = ( \begin{matrix}1 \\ i\end{matrix} ) exp ( {iα}_{1} )$$

After the first linear polarizer the amplitude is

$${E}_{2} = ( \begin{matrix}1 \\ 0\end{matrix} ) exp ( {iα}_{1} )$$

For calculation of the polarization rotation by the second Faraday rotator, the linear polarization is decomposed into left and right circular polarization states which are phase shifted by α₂ and −α₂, respectively, with

α₂=V₂L₂H₂V₂N₂I₂

The amplitude after the second Faraday rotator is

$$\begin{matrix}{E}_{3} = \frac{1}{2} exp ( {iα}_{1} ) \cdot [ ( \begin{matrix}1 \\ i\end{matrix} ) exp ( {iα}_{2} ) + ( \begin{matrix}1 \\ - i\end{matrix} ) exp ( - {iα}_{2} ) ] \\ = exp ( {iα}_{1} ) \cdot ( \begin{matrix}cos ( {α}_{2} ) \\ - sin ( {α}_{2} )\end{matrix} )\end{matrix}$$

Finally, after the second linear polarizer the amplitude is

$${E}_{4} = exp ( {iα}_{1} ) \cdot ( \begin{matrix}cos ( {α}_{2} ) \\ 0\end{matrix} )$$

The two MOSLM modulate the amplitude by |cos(α₂)| and the phase by α₁.

Therefore coil currents I₁ and I₂ can be used to control each pixel phase α₁ and amplitude factor |cos(α₂)|, because these quantities are respectively equal to V₁N₁I₁ and |cos(V₂N₂I₂)|.

We now give a specific example of an implementation. Two MOSLMs are combined in series. Each layer contains modulating pixels that are controlled by coils and addressed independently. The layers are aligned such that light modulated in a pixel of the first layer is subsequently modulated by the corresponding pixel of the second layer. The modulation characteristic of each layer is such that the two layers acting in series facilitate complex modulation of light, i.e. amplitude and phase. Optionally, the SLM may comprise an array of controllable prism elements that facilitate beam steering. Optionally, the SLM may comprise an integrated computer.

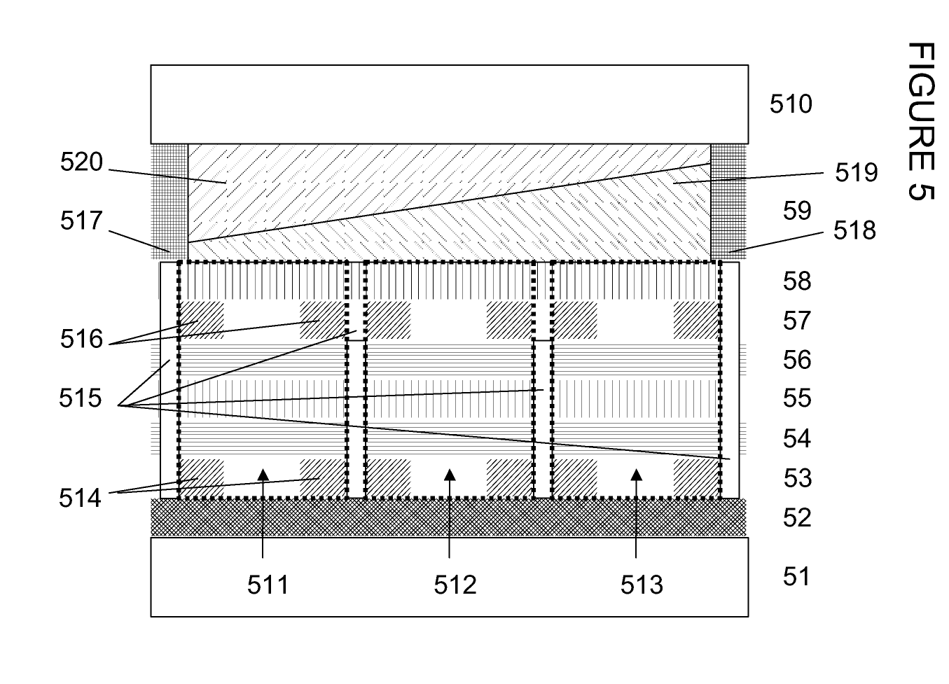

FIG. 5 shows a cross section through such an SLM comprising
two layers of magneto-optic modulators 53, 54, 56, 57
a prism element 59 for beam steering
a computer integrated in the SLM for calculation of the hologram and controlling the modulators and the prism element. This may be called a computer in a display (CIAD) 52. The circuitry for such a computer may be grown on a glass substrate, as described in patent applications GB 0709376.8, GB 0709379.2 by the applicant. A real device would have many more pixels than the three pixels shown in FIG. 5 e.g. a real device could have an array of 1,000 by 1,000 pixels which would give a million pixels.

The device shown in FIG. 5 comprises three pixels 511, 512 and 513 and one prism element 59. It is understood that the implementation is not restricted to these numbers and to this ratio 3:1.

The SLM shown in FIG. 5 comprises several layers with
a bottom glass substrate 51
a computer CIAD 52
a first layer with coils 53 of which the cross sections of three coils are shown
a first magneto-photonic crystal layer 54
a first polarizer 55
a second magneto-photonic crystal layer 56
a second layer with coils 57 of which the cross sections of three coils are shown
a second polarizer 58
a prism element 59 for beam steering
a top glass substrate 510.

Three pixels 511, 512, 513 are shown in FIG. 5. Each pixel stack extends from the first layer of coils 53 to the second polarizer 58, as indicated by the dashed lines. The SLM will be explained with respect to pixel 511. The direction of light propagation is from the bottom glass substrate 51 to the top glass substrate 510.

The coil 514 generates a magnetic field and controls the modulation of the light in the first magneto-photonic crystal layer (MPC) 54. The light passes the first polarizer 55 and is then modulated by the second MPC 56 that is controlled by the second coil 516. The second polarizer 58 is at the output of pixel 511. Each MPC consists of a multi-layer structure of magneto-optic layers that significantly enhance the Verdet constant. Some description of the MPC multi-layer structure is given in “A Presentation for Investors” by Panorama Labs of Rockefeller Center, 1230 Avenue of the Americas, 7th Floor, New York, N.Y. 10020 USA (www.panoramalabs.com), obtained from the internet.

The two MPC 54, 56 are used to modulate the phase and amplitude of the light passing through each pixel. As an example, the light entering pixel 511 is in a left-hand circularly polarized state. After having passed MPC 54 the light is still left-hand circularly polarized and has a phase shift φ1 that depends on the magnetic field generated by coil 514. The polarizer 55 transfers the left-hand circular polarization to a linear polarization with constant amplitude and the phase shift φ1. This light is then modulated within MPC 56. Afterwards, the polarization is still linear but the direction of polarization is rotated by an angle α that depends on the magnetic field generated by coil 516. After the second linear polarizer 58 the light has a constant direction of polarization and an amplitude that depends on the rotation angle α.

The above is one example of how to modulate phase and amplitude of light in a pixel with two MPCs. It is to be understood that other combinations of modulation characteristics, input and output polarizations and polarizer orientations are possible, as will be obvious to those skilled in the art. There may be a mixed modulation of amplitude and phase in each MPC. For full complex modulation, it is essential that the combined modulation in MPC 54 and MPC 56 facilitates a controllable complex modulation of amplitude from zero to the maximum amplitude value and of the phase from 0 to 2π radians.

The optional layer with the prism element 59 comprises electrodes 517, 518 and a cavity filled with two separate liquids 519, 520. Each liquid fills a prism-shaped part of the cavity. As an example, the liquids may be oil and water. The slope of the interface between the liquids 519, 520 depends on the voltage applied to the electrodes 517, 518. If the liquids have different refractive indices the light beam will experience a deviation that depends on the voltage applied to the electrodes 517, 518. Hence the prism element 59 acts as a controllable beam steering element. This is an important feature for the applicant's preferred approach to electro-holography which requires tracking of VOWs to the observers' eyes. Patent applications DE 102007024237.0, DE 102007024236.2 filed by the applicant describe tracking of VOWs to the observers' eyes with prism elements.

The optional CIAD 52 is used to calculate the hologram and to control the currents in the coils of the pixels and to control the prism elements. Patent applications GB 0709376.8, GB 0709379.2 filed by the applicant describe the implementation of CIAD for holographic displays.

The CIAD 52 in FIG. 5 is directly attached to the bottom glass substrate and is made using thin film transistor (TFT) technology. The control signals to the coils and the prism elements are transferred via feedthroughs or conducting contacts that are indicated by label 515 in FIG. 5. This is just one example. Other positions of the CIAD are possible, e.g.:
Two CIAD, one on the bottom and one on the top substrate. The synchronization may be via feedthroughs or externally by synchronized operation of the two CIAD.
Two CIAD, one on each side of the polarizer 55. This would ensure short distances to the coils.
One or two CIAD on one or both sides of a flexible sheet that is attached to the glass substrates, the MPC, the coils or the polarizer.

It is understood that the implementation is not limited to this list of locations of the CIAD.

There are several possibilities for the feedthroughs or contacts between CIAD, coils and electrodes of the prism element or between several CIAD, e.g.:
Etching or drilling of holes, or photolithographic fabrication of holes, and filling with a conduction material.
Gluing of contact areas on one layer to contact areas on another layer with conducting adhesive.
Manufacturing a compound multi-layer sheet that may include one or several CIAD, the polarizer or the coils.

It will be understood that the implementation is not limited to this list of possibilities.

Care has to be taken to avoid or to compensate for crosstalk between magnetic fields.
A crosstalk between the magnetic fields of first coil 514 and second coil 516 (stray fields) that would cause an error to the light modulation can be calculated and compensated. The calculation and compensation can be made in real time or using a look-up table (LUT).
A crosstalk between neighboring pixels typically may be neglected as the stray fields away from the axis of a coil are small. Otherwise, the crosstalk may be calculated or compensated for, either online or using a LUT.
A crosstalk of the stray fields of the CIAD to the MPC (and vice versa) can be minimized by careful design of the layout. As an example, circuit paths with equal current in opposite directions can be positioned close together in order that the far-field magnetic fields cancel to a good approximation.

Crosstalk of light from one pixel to the neighboring pixels can be avoided by a short optical path from 53 to 58 (i.e in the direction perpendicular to 51 towards 510 in FIG. 5) within a pixel. This reduces the amount of diffracted light to the neighboring pixel to a negligible value.

The polarizers 55, 58 should be a thin layers, too. Examples include:
Polymer sheet polarizer
Layer with embedded small metal particles that absorb one polarization direction.
A wire grid polarizer, consisting of an array of parallel nano-structured wires that transmit light of one polarization direction and reflect the other polarization direction (e.g. those produced by Moxtek Inc. of 452 West 1260 North, Orem, Utah 84057, USA).

The whole SLM may be either a small SLM with a diagonal of the order of a few cm such as one that may be used as a mobile phone sub-display, or with a diagonal of one cm or less such as one for use in a projection display where the SLM is optically enlarged. Or it might be a large SLM with a diagonal of the order of up to one metre or more for use in a direct-view display where the SLM is seen by several observers in its actual size. SLM diagonal sizes between the small and large sizes are also possible for various applications.

The SLM described in the above example has the features
Two MPC for independent modulation of amplitude and phase
Prism elements for beam steering
CIAD for hologram calculation and control of coils and prism elements.

It is also possible to manufacture a less complex SLM:
A SLM without prism elements could be used in combination with external beam steering elements, e.g. light-source tracking, scanning mirrors or external prism elements.
A SLM without CIAD could be used with an external computer for hologram calculation and control of coils and prism elements.
A SLM without eye tracking could be used in a hand-held device, where the user orients the device with the hand so as to place the VOWs at the positions of his eyes.

The disclosed SLM is preferably used for a holographic display, either a projection holographic display or a direct-view holographic display. The SLM with integrated prism elements for beam steering is preferable for a holographic display based on the applicant's preferred approach to holographic displays which uses tracked VOWs.

While the applicant's preferred approach to holographic encoding, through the use of virtual observer windows, is described in eg. WO 2004/044659 (US2006/0055994) filed by the applicant which describes a device for reconstructing three-dimensional scenes by way of diffraction of sufficiently coherent light, it should be understood that the holographic display of this implementation is not restricted to such an approach, but includes all known holographic display types which may be used together with a pair of MOSLMs to effect complex holographic encoding, as would be obvious to one skilled in the art.

### C. Compact Combination of an MOSLM and a Compact Light Source

This implementation provides a compact combination of an MOSLM and a compact light source of sufficient coherence, the combination being capable of generating a three dimensional image under suitable illumination conditions.

In this implementation, a compact combination of an MOSLM and a compact light source, with no requirement for imaging optics, is described. This implementation provides a compact combination of a light source or sources, a focusing means, an MOSLM and an optional beam splitter element, the combination being capable of generating a three dimensional image under suitable illumination conditions. By “no requirement for imaging optics,” it is meant that there is no focusing means apart from the means for focusing the light sources or sources, such means being typically a microlens array, for example.

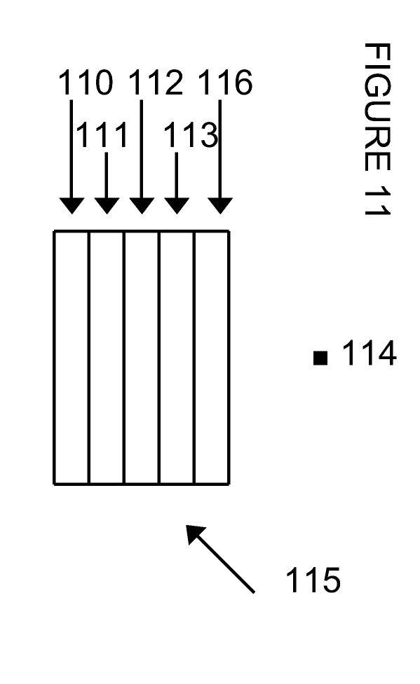

In FIG. 11, an example of an implementation is disclosed. 110 is an illumination apparatus for providing illumination of a plane area, where the illumination has sufficient coherence so as to be able to lead to the generation of a three dimensional image. An example of an illumination apparatus is disclosed in US 2006/250671 for the case of large area video holograms, one example of which is reproduced in FIG. 4. Such an apparatus as 110 may take the form of an array of white light sources, such as cold cathode fluorescent lamps or white light light emitting diodes which emit light which is incident on a focusing system which may be compact, such as a lenticular array or a microlens array. Alternatively, light sources for 110 may comprise of red, green and blue lasers or red, green and blue light emitting diodes which emit light of sufficient coherence. The red, green and blue light emitting diodes may be organic light emitting diodes (OLEDs). However, non-laser sources with sufficient spatial coherence (eg. light emitting diodes, OLEDs, cold cathode fluorescent lamps) are preferred to laser sources. Laser sources have disadvantages such as causing laser speckle in the holographic reconstructions, being relatively expensive, and having possible safety problems with regard to possibly damaging the eyes of holographic display viewers or of those who work in assembling the holographic display devices.

Element 110 may include one or two prismatic optical films for increasing display brightness: such films are disclosed eg. in U.S. Pat. No. 5,056,892 and in U.S. Pat. No. 5,919,551, though others are known.

Element 110 may be about a few centimetres in thickness, or less. In a preferred implementation, elements 110-113, 116 in total are less than 3 cm in thickness, so as to provide a compact source of light of sufficient coherence. Element 111 may comprise of an array of colour filters, such that pixels of coloured light, such as red, green and blue light, are emitted towards element 112, although the colour filters may not be required if coloured sources of light are used. Element 112 is a polarizing element, or a set of polarizing elements. Element 113 is a MOSLM. Element 116 is a polarizing element, or a set of polarizing elements. Element 116 may be followed by an optional beamsplitter element. A viewer located at point 114 some distance from the device which includes the compact hologram generator 115 may view a three dimensional image when viewing in the direction of 115.

Optical components described in section A may be included in the compact hologram generator 115, as would be obvious to one skilled in the art.

An MOSLM is a SLM in which each cell in an array of cells may be addressed electrically, so as to modulate the polarization state of polarized light by the Faraday effect. Each cell acts on the light incident on it some way, such as to modulate the amplitude of the light it transmits, or to modulate the phase of the light it transmits, or to modulate some combination of the amplitude and phase of the light it transmits. An example of an MOSLM is given in WO2005/076714A2, but other such SLMs are also known.

Elements 110, 111, 112, 113 and 116 are disposed so as to be in physical, e.g. actual mechanical, contact, each forming a layer of a structure so that the whole is a single, unitary object. Physical contact may be direct. Or it may be indirect, if there is a thin, intervening layer, coating of film between adjacent layers. Physical contact may be limited to small regions that ensure correct mutual alignment or registration, or may extend to larger areas, or the entire surface of a layer. Physical contact may be achieved by layers being bonded together such as through the use of an optically transmitting adhesive, so as to form a compact hologram generator 115, or by any other suitable process (see also section below titled Outline Manufacturing Process).

FIG. 4 is a prior art side view showing three focusing elements 1101, 1102, 1103 of a vertical focusing system 1104 in the form of cylindrical lenses horizontally arranged in an array. The nearly collimated beams of a horizontal line light source LS₂ passing through the focusing element 1102 of an illumination unit and running to an observer plane OP are exemplified. According to FIG. 4, a multitude of line light sources LS₁, LS₂, LS₃ are arranged one above another. Each light source emits light which is sufficiently coherent in the vertical direction and which is incoherent in the horizontal direction. This light passes through the transmissive cells of the light modulator SLM. The light is only diffracted in the vertical direction by cells of the light modulator SLM, which are encoded with a hologram. The focusing element 1102 images a light source LS₂ in the observer plane OP in several diffraction orders, of which only one is useful. The beams emitted by the light source LS₂ are exemplified to pass only through the focusing element 1102 of focusing system 1104. In FIG. 4 the three beams show the first diffraction order 1105, the zeroth order 1106 and the minus first order 1107. In contrast to a single point light source, a line light source allows the production of a significantly higher luminous intensity. Using several holographic regions with already increased efficiency and with the assignment of one line light source for each portion of a 3D-scene to be reconstructed, improves the effective luminous intensity. Another advantage is that, instead of a laser, a multitude of conventional light sources, which are positioned e.g. behind a slot diaphragm, which may also be part of a shutter, generate sufficiently coherent light.

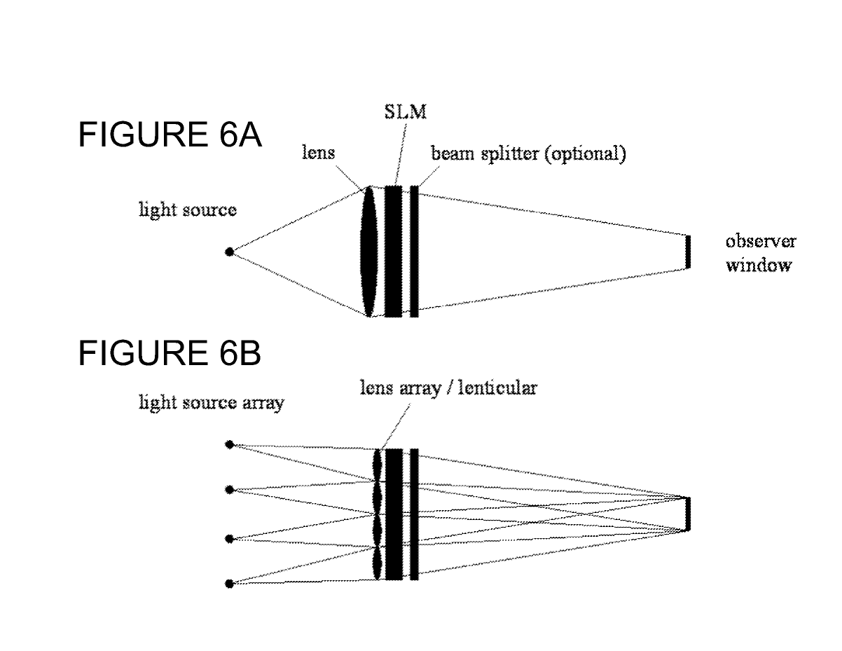

In general, a holographic display is used to reconstruct a wavefront in a virtual observer window. The wavefront is one that a real object would generate, if it were present. An observer sees the reconstructed object when his eyes are positioned at an virtual observer window, which may be one of several possible virtual observer windows (VOWs). As shown in FIG. 6A, the holographic display comprises the following components: a light source, a lens, a SLM, and an optional beam splitter.

In order to facilitate the creation of a compact combination of a SLM and a compact light source which may display holographic images, the single light source and the single lens of FIG. 6A may be replaced by a light source array and a lens array or a lenticular array, respectively, as shown in FIG. 6B. In FIG. 6B, the light sources illuminate the SLM and the lenses image the light sources into the observer plane. The SLM is encoded with a hologram and modulates the incoming wavefront such that the desired wavefront may be reconstructed in the VOW. An optional beam splitter element may be used to generate several VOWs, e.g. one VOW for the left eye and one VOW for the right eye.

If a light source array and a lens array or a lenticular array are used, the light sources in the array have to be positioned such that the light bundles through all the lenses of the lens array or lenticular array coincide in the VOW.

The apparatus of FIG. 6B lends itself to a compact design that can be used for a compact holographic display. Such a holographic display may be useful for mobile applications, e.g. in a mobile phone or a PDA. Typically, such a holographic display would have a screen diagonal of the order of one inch or several inches. The appropriate components are described in detail below.

### 1) Light Source/Light Source Array

In a simple case, a fixed single light source can be used. If an observer moves, the observer may be tracked, and the display may be adjusted so as to create an image which is viewable at the new position of the observer. Here, there is either no tracking of the VOW or tracking is performed using a beam steering element after the SLM.

A configurable light source array may be achieved by a further MOSLM that is illuminated by a backlight. Only the appropriate pixels are switched to the transmission state in order to create an array of point or line light sources. The maximum switching speed of such an array will be much faster than in other SLMs such as those using LC or MEMS technologies. The apertures of these light sources have to be sufficiently small to guarantee sufficient spatial coherence for holographic reconstruction of an object. An array of point light sources may be used in combination with a lens array that comprises a 2D arrangement of lenses. An array of line light sources is preferably used in combination with a lenticular array that comprises a parallel arrangement of cylindrical lenses.

Preferably, an OLED display is used as a light source array. When an OLED display is used as a light source array only those pixels are switched on that are necessary for generating the VOW at the eye positions. The OLED display may have a 2D arrangement of pixels or a 1D arrangement of line light sources. The emitting area of each point light source or the width of each line light source has to be sufficiently small to guarantee sufficient spatial coherence for holographic reconstruction of an object. Again, an array of point light sources is preferably used in combination with a lens array that comprises a 2D arrangement of lenses. An array of line light sources is preferably used in combination with a lenticular array that comprises a parallel arrangement of cylindrical lenses.

### 2) Focusing Means

### Single Lens, Lens Array or Lenticular Array

The focusing means images the light source or the light sources to the observer plane. As the SLM is in close proximity to the focusing means, the Fourier transform of the information encoded in the SLM is in the observer plane. The focusing means comprises one or several focusing elements. The positions of SLM and of the focusing means may be swapped.

For a compact combination of a MOSLM and a compact light source of sufficient coherence, it is essential to have a thin focusing means: a conventional refractive lens with a convex surface would be too thick. Instead, a diffractive or a holographic lens may be used. This diffractive or holographic lens may have the function of a single lens, of a lens array or of a lenticular array. Such materials are available as surface relief holographic products supplied by Physical Optics Corporation, Torrance, Calif., USA. Alternatively, a lens array may be used. A lens array comprises a 2D arrangement of lenses, where each lens is assigned to one light source of the light source array. In another alternative, a lenticular array may be used. A lenticular array comprises a 1D arrangement of cylindrical lenses, where each lens has a corresponding light source in the light source array. As mentioned above, if a light source array and a lens array or a lenticular array are used, the light sources in the array have to be positioned such that the light bundles through all the lenses of the lens array or the lenticular array coincide in the VOW.

The light through the lenses of the lens array or the lenticular array is incoherent for one lens with respect to any other lens. Therefore the hologram that is encoded on the SLM is composed of sub-holograms, where each sub-hologram corresponds to one lens. The aperture of each lens has to be sufficiently large to guarantee sufficient resolution of the reconstructed object. One may use lenses with an aperture that is approximately as large as the typical size of an encoded area in the hologram, as has been described in US2006/0055994. This means that each lens should have an aperture of the order of one or several millimeters.

### 3) SLM

The hologram is encoded on the SLM. Usually, the encoding for a hologram consists of a 2D array of complex numbers. Hence, ideally the SLM would be able to modulate the amplitude and the phase of the local light beams passing through each pixel of the SLM. However, a typical SLM is capable of modulating either amplitude or phase and not amplitude and phase independently.

An amplitude-modulating SLM may be used in combination with detour-phase encoding, e.g. Burckhardt encoding. Its drawbacks are that three pixels are needed to encode one complex number and the reconstructed object has a low brightness.

A phase-modulating SLM results in a reconstruction with higher brightness. As an example, a so-called 2-phase encoding may be used that needs two pixels to encode one complex number.

Although MOSLMs have the property of sharply-defined edges, which lead to unwanted higher diffraction orders in their diffraction patterns, the use of soft apertures can reduce or eliminate this problem. Soft apertures are apertures without a sharp transmission cut off. An example of a soft aperture transmission function is one with a Gaussian profile. Gaussian profiles are known to be advantageous in diffractive systems. The reason is that there is a mathematical result that the Fourier transform of a Gaussian function is itself a Gaussian function. Hence the beam intensity profile function is unchanged by diffraction, except for a lateral scaling parameter, in contrast to the case for transmission through an aperture with a sharp cut-off in its transmission profile. Sheet arrays of Gaussian transmission profiles may be provided. When these are provided in alignment with the MOSLM apertures, a system is provided in which higher diffraction orders will be absent, or will be significantly reduced, compared with systems with a sharp cut off in the beam transmission profiles.

### 4) Beam Splitter Element

The VOW is limited to one periodicity interval of the Fourier transform of the information encoded in the SLM. With the currently available SLMs of maximum resolution, the size of the VOW is of the order of 10 mm. In some circumstances, this may be too small for application in a holographic display without tracking. One solution to this problem is spatial multiplexing of VOWs: more than one VOWs are generated. In the case of spatial multiplexing the VOWs are generated simultaneously from different locations on the SLM. This may be achieved by beam splitters. As an example, one group of pixels on the SLM is encoded with the information of VOW1, another group with the information of VOW2. A beam splitter separates the light from these two groups such that VOW1 and VOW2 are juxtaposed in the observer plane. A larger VOW may be generated by seamless tiling of VOW1 and VOW2. Multiplexing may also be used for generation of VOWs for the left and the right eye. In that case, seamless juxtaposition is not required and there may be a gap between one or several VOWs for the left eye and one or several VOWs for the right eye. Care has to be taken that higher diffraction orders of one VOW do not overlap in the other VOWs.

A simple example of a beam splitter element is a parallax barrier consisting of black stripes with transparent regions in between, as described in US2004/223049, which is incorporated herein by reference. A further example is a lenticular sheet, as described in US2004/223049. Further examples of beam splitter elements are lens arrays and prism masks. In a compact holographic display, one would typically expect a beam splitter element to be present, as the typical virtual observer window size of 10 mm would only be large enough for one eye, which is unsatisfactory as the typical viewer has two eyes which are approximately 10 cm apart. However, as an alternative to spatial multiplexing, temporal multiplexing may be used. Temporal multiplexing is enabled by the use of MOSLMs, because MOSLMs have very fast switching capabilities, as discussed above. In the absence of spatial multiplexing, a beam splitter element does not have to be used.

Spatial multiplexing may also be used for the generation of color holographic reconstructions. For spatial color multiplexing there are separate groups of pixels for each of the color components red, green and blue. These groups are spatially separated on the SLM and are simultaneously illuminated with red, green and blue light. Each group is encoded with a hologram calculated for the respective color component of the object. Each group reconstructs its color component of the holographic object reconstruction.

### 5) Temporal Multiplexing

In the case of temporal multiplexing the VOWs are generated sequentially from the same location on the SLM. This may be achieved by alternating positions of the light sources and synchronously re-encoding the SLM. The alternating positions of the light sources have to be such that there is seamless juxtaposition of the VOWs in the observer plane. If the temporal multiplexing is sufficiently fast, i.e. >25 Hz for the complete cycle, the eye will see a continuous enlarged VOW.

Multiplexing may also be used for generation of VOWs for the left and the right eye. In that case, seamless juxtaposition is not required and there may be a gap between one or several VOWs for the left eye and one or several VOWs for the right eye. This multiplexing may be spatial or temporal.

Spatial and temporal multiplexing may also be combined. As an example, three VOWs are spatially multiplexed to generate an enlarged VOW for one eye. This enlarged VOW is temporally multiplexed to generate an enlarged VOW for the left eye and an enlarged VOW for the right eye.

Care has to be taken that higher diffraction orders of one VOW do not overlap in the other VOWs.

Multiplexing for the enlargement of VOWs is preferably used with re-encoding of the SLM as it provides an enlarged VOW with continuous variation of parallax upon observer motion. As a simplification, multiplexing without re-encoding would provide repeated content in different parts of the enlarged VOW.

Temporal multiplexing may also be used for the generation of color holographic reconstructions. For temporal multiplexing the holograms for the three color components are sequentially encoded on the SLM. The three light sources are switched synchronously with the re-encoding on the SLM. The eye sees a continuous color reconstruction if the complete cycle is repeated sufficiently fast, i.e. with >25 Hz.

Temporal multiplexing is enabled by the use of MOSLMs, because MOSLMs have very fast switching capabilities, as discussed above.

### 6) Eye Tracking

In a compact combination of an MOSLM and a compact light source of sufficient coherence with eye tracking, an eye position detector may detect the positions of the observer's eyes. One or several VOWs are then automatically positioned at the eye positions so that the observer can see the reconstructed object through the VOWs.

However, tracking may not always be practical, especially for portable devices, because of the constraints of the additional apparatus required and electrical power requirements for its performance. Without tracking, the observer has to manually adjust the position of the display. This is readily performed as in a preferred implementation the compact display is a hand-held display that may be incorporated in a PDA or a mobile phone. As the user of a PDA or mobile phone usually tends to look perpendicularly on the display there is not much additional effort to align the VOWs with the eyes. It is known that a user of a hand-held device will tend automatically to orient the device in the hand so as to achieve the optimum viewing conditions, as described for example in WO01/96941, which is incorporated herein by reference. Therefore, in such devices there is no necessity for user eye tracking and for complicated and non-compact tracking optics comprising scanning mirrors, for example. But eye tracking could be implemented for such devices if the additional requirements for apparatus and electrical power do not impose an excessive burden.

Without tracking, a compact combination of a MOSLM and a compact light source of sufficient coherence requires VOWs that are sufficiently large in order to simplify the adjusting of the display. Preferably the VOW size should be several times the size of the eye pupil. This can be achieved by either a single large VOW, using a SLM with a small pitch, or by the tiling of several small VOWs, using a SLM with a large pitch.

The position of the VOWs is determined by the positions of the light sources in the light source array. An eye position detector detects the positions of the eyes and sets the positions of the light sources in order to adapt the VOWs to the eye positions. This kind of tracking is described in US2006/055994 and in US2006/250671.

Alternatively, VOWs may be moved when the light sources are in fixed positions. Light source tracking requires a SLM that is relatively insensitive to the variation of the incidence angle of light from the light sources. If the light source is moved in order to move the VOW position, this may be difficult to achieve with a compact combination of a compact light source and a SLM due to the possible off-normal light propagation conditions within the compact combination that such a configuration implies. In such a case it is advantageous to have a constant optical path in the display and a beam steering element as the last optical component in the display.

### 7) Example

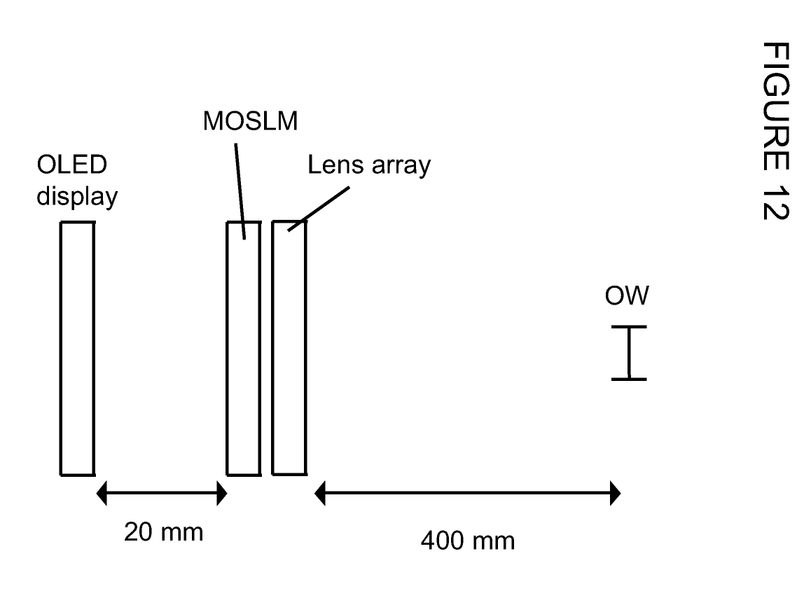

An example will now be described of a compact combination of an MOSLM and a compact light source of sufficient coherence, the combination being capable of generating a three dimensional image under suitable illumination conditions, that may be incorporated in a PDA or a mobile phone. The compact combination of an MOSLM and a compact light source of sufficient coherence comprises an OLED display as the light source array, an MOSLM and a lens array, as shown in FIG. 12. A VOW is denoted OW in FIG. 12.

Depending on the required position of the VOW, specific pixels in the OLED display are activated. These pixels illuminate the MOSLM and are imaged into the observer plane by the lens array. At least one pixel per lens of the lens array is activated in the OLED display. With the dimensions given in the drawing, the VOW can be tracked with a lateral increment of 400 μm if the pixel pitch is 20 μm. This tracking is quasi-continuous.

An OLED pixel is a light source with only partial spatial coherence. Partial coherence leads to a smeared reconstruction of the object points. With the dimensions given in the drawing, an object point at a distance of 100 mm from the display is reconstructed with a lateral smearing of 100 μm if the pixel width is 20 μm. This is sufficient for the resolution of the human vision system.

There is no significant mutual coherence between the light that passes through different lenses of the lens array. The coherence requirement is limited to each single lens of the lens array. Therefore, the resolution of a reconstructed object point is determined by the pitch of the lens array. A typical lens pitch will therefore be of the order of 1 mm to guarantee sufficient resolution for the human vision system. If the OLED pitch is 20 μm, this means that the ratio of the lens pitch to the OLED pitch is 50:1. If only a single OLED is lit per lens, this means that only one OLED in every 50̂2=2,500 OLEDs will be lit. Hence the display will be a low power display. A difference between the holographic display of an implementation and a conventional OLED display is that the former concentrates the light at the viewer's eyes, whereas the latter emits light into 2π steradians. Whereas a conventional OLED display achieves a luminance of about 1,000 cd/m̂2, the inventors calculate that in this implementation, the illuminated OLED should achieve a luminance of several times 1,000 cd/m̂2 for practical application.

The VOW is limited to one diffraction order of the Fourier spectrum of the information encoded in the SLM. At a wavelength of 500 nm the VOW has a width of 10 mm if the pixel pitch of the MOSLM is 20 μm. The VOW may be enlarged by tiling of VOWs by spatial or temporal multiplexing. In the case of spatial multiplexing additional optical elements such as beam splitters are required.

Color holographic reconstructions can be achieved by temporal multiplexing. The red, green and blue pixels of a color OLED display are sequentially activated with synchronous re-encoding of the SLM with holograms calculated for red, green and blue optical wavelengths.

The display may comprise an eye position detector that detects the positions of the observer's eyes. The eye position detector is connected with a control unit that controls the activation of pixels of the OLED display.

The calculation of the holograms that are encoded on the SLM is preferably performed in an external encoding unit as it requires high computational power. The display data are then sent to the PDA or mobile phone to enable the display of a holographically-generated three dimensional image.

### D. Compact Combination of a Pair of MOSLMs

In a further implementation, a combination of two MOSLMs can be used to modulate the amplitude and the phase of light in sequence and in a compact way. Thus, a complex number, which consists of an amplitude and a phase, can be encoded in the transmitted light, on a pixel by pixel basis.

This implementation comprises a compact combination of two MOSLMs. The first MOSLM modulates the amplitude of transmitted light and the second MOSLM modulates the phase of the transmitted light. Alternatively, the first MOSLM modulates the phase of transmitted light and the second MOSLM modulates the amplitude of the transmitted light—this is thought to be preferable as one expects the phase to be modulated more accurately (i.e. with proportionately less noise) while the amplitude is at its maximum value. Each MOSLM may be as described in section C above. An overall assembly may be as described in the section C, except two MOSLMs are used here. Any other combination of modulation characteristics of the two MOSLMs is possible that is equivalent to facilitating independent modulation of amplitude and phase.

In a first step the first MOSLM is encoded with the pattern for amplitude modulation. In a second step the second MOSLM is encoded with the pattern for phase modulation. The light transmitted by the second MOSLM has been modulated in its amplitude and in its phase as a result of which an observer may observe a three dimensional image when viewing the light emitted by the device in which the two MOSLMs are housed.

It will be appreciated by those skilled in the art that the modulation of phase and amplitude facilitates the representation of complex numbers. Furthermore, MOSLMs may have high resolution. Therefore, this implementation may be used to generate holograms such that a three dimensional image may be viewed by a viewer.

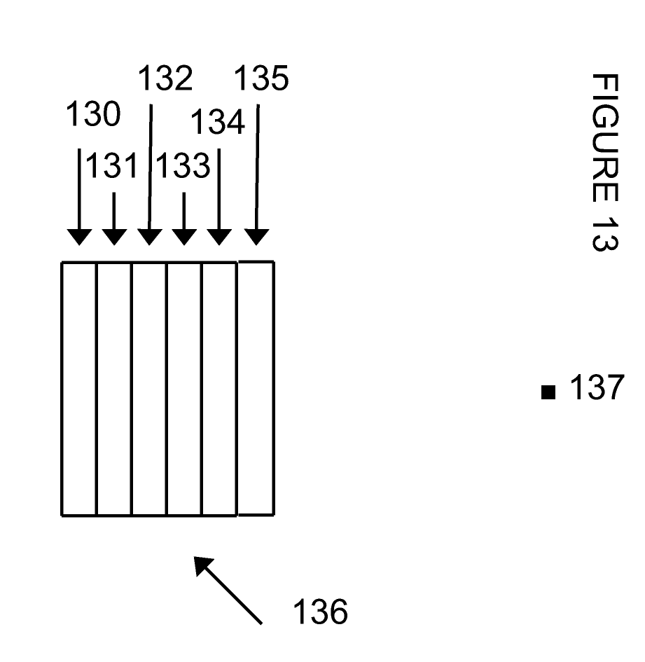

In FIG. 13, an example of an implementation is disclosed. 130 is an illumination apparatus for providing illumination of a plane area, where the illumination has sufficient coherence so as to be able to lead to the generation of a three dimensional image. An example of an illumination apparatus is disclosed in US 2006/250671 for the case of large area video holograms, one example of which is reproduced in FIG. 4. Such an apparatus as 130 may take the form of an array of white light sources, such as cold cathode fluorescent lamps or white light light emitting diodes which emit light which is incident on a focusing system which may be compact, such as a lenticular array or a microlens array. Alternatively, light sources for 130 may comprise of red, green and blue lasers or red, green and blue light emitting diodes which emit light of sufficient coherence. The red, green and blue light emitting diodes may be organic light emitting diodes (OLEDs). However, non-laser sources with sufficient spatial coherence (eg. light emitting diodes, OLEDs, cold cathode fluorescent lamps) are preferred to laser sources. Laser sources have disadvantages such as causing laser speckle in the holographic reconstructions, being relatively expensive, and having possible safety problems with regard to possibly damaging the eyes of holographic display viewers or of those who work in assembling the holographic display devices.

Element 130 may be about a few centimetres in thickness, or less. In a preferred implementation, elements 130-135 are less than 3 cm in thickness in total, so as to provide a compact source of light of sufficient coherence. Element 131 may comprise of an array of colour filters, such that pixels of coloured light, such as red, green and blue light, are emitted towards element 132, although the colour filters may not be required if coloured sources of light are used. Element 132 is a polarizing element or a set of polarizing elements. Element 133 is an MOSLM. Element 134 is an MOSLM. Elements 133 and 134 each contain a polarizing element or a set of polarizing elements. Element 135 is an optional beamsplitter element. With regard to the transmitted light, element 133 modulates the amplitude and element 134 modulates the phase. Alternatively, element 134 modulates the amplitude and element 133 modulates the phase. The close proximity of MOSLMs 134 and 133 enables a reduction in the problems of optical losses and pixel cross-talk arising from optical beam divergence: when MOSLMs 134 and 133 are in closer proximity, a better approximation to non-overlapping propagation of the beams of coloured light through the MOSLMs may be achieved. A viewer located at point 137 some distance from the device which includes the compact hologram generator 136 may view a three dimensional image when viewing in the direction of 136.

Elements 130, 131, 132, 133, 134 and 135 are arranged so that adjacent elements are in physical, e.g. fixed mechanical, contact, each forming a layer of a structure so that the whole is a single, unitary object. Physical contact may be direct. Or it may be indirect, if there is a thin, intervening layer, coating of film between adjacent layers. Physical contact may be limited to small regions that ensure correct mutual alignment or registration, or may extend to larger areas, or the entire surface of a layer. Physical contact may be achieved by layers being bonded together such as through the use of an optically transmitting adhesive, so as to form a compact hologram generator 136, or by any other suitable process (see also section below titled Outline Manufacturing Process).

Where an MOSLM performs amplitude modulation, in a typical configuration the incident optical beams will be linearly polarized by passing the beams through a linear polarizer sheet. Amplitude modulation is controlled by the rotation of the linear polarization state in an applied magnetic field along the direction of light propagation, which influences the polarization state of the light through the Faraday effect. In such a device, the light which exits the MOSLM is passed through a further linear polarizer sheet, which enables intensity reduction as a result of any rotation in the polarization state of the light as it passes through the MOSLM.

Where an MOSLM performs phase modulation, in a typical configuration the incident read optical beams will be circularly polarized by passing the beams through a linear polarizer sheet and a quarter wave plate. Phase modulation is controlled by application of a magnetic field along the direction of light propagation, which influences the phase state of the light, via the Faraday effect. The directed magnetic field is generated by current which flows through a coil. In phase modulation, for each pixel the output beam has a phase difference with respect to the input beam that is a function of the current which flows through the coil corresponding to each pixel.

A compact assembly for use in a compact holographic display comprises two MOSLMs that are joined with a small or a minimal separation. In a preferred implementation, both SLMs have the same number of pixels. Because the two MOSLMs are not equidistant from the observer, the pixel pitch of the two MOSLMs may need to be slightly different to compensate for the effect of being at different distances with respect to observer. The light that has passed through a pixel of the first SLM passes through the corresponding pixel of the second SLM. Therefore, the light is modulated by both SLMs, and complex modulation of amplitude and phase independently can be achieved. As an example, the first SLM is amplitude-modulating and the second SLM is phase-modulating. Also, any other combination of modulation characteristics of the two SLMs is possible that together facilitates independent modulation of amplitude and phase.

Care has to be taken that light that has passed through a pixel of the first SLM passes only through the corresponding pixel of the second SLM. Crosstalk will occur if light from a pixel of the first SLM passes through non-corresponding, neighboring pixels of the second SLM. This crosstalk may lead to a reduced image quality. Here are four possible approaches to the problem of minimizing the cross-talk between pixels. It will be apparent to those skilled in the art that these approaches may also be applied to the implementation in section B.

(1) The first and simplest approach is to directly join or glue together two SLMs, with aligned pixels. There will be diffraction at a pixel of the first SLM which causes a diverging propagation of light. The separation between the SLMs has to be such as to keep to acceptable levels the crosstalk between neighboring pixels of the second SLM. As an example, with a pixel pitch of 10 μm the separation of the two MOSLMs has to be less than or equal to the order of 10-100 μm. This can hardly be achieved with conventionally manufactured SLMs, as the thickness of the cover glass is of the order of 1 mm. Rather, the sandwich is preferably manufactured in one process, with only a thin separation layer between the SLMs. Manufacturing approaches outlined in the section Outline Manufacturing Process may be applied to making a device which includes two MOSLMs separated by a small or minimal distance.

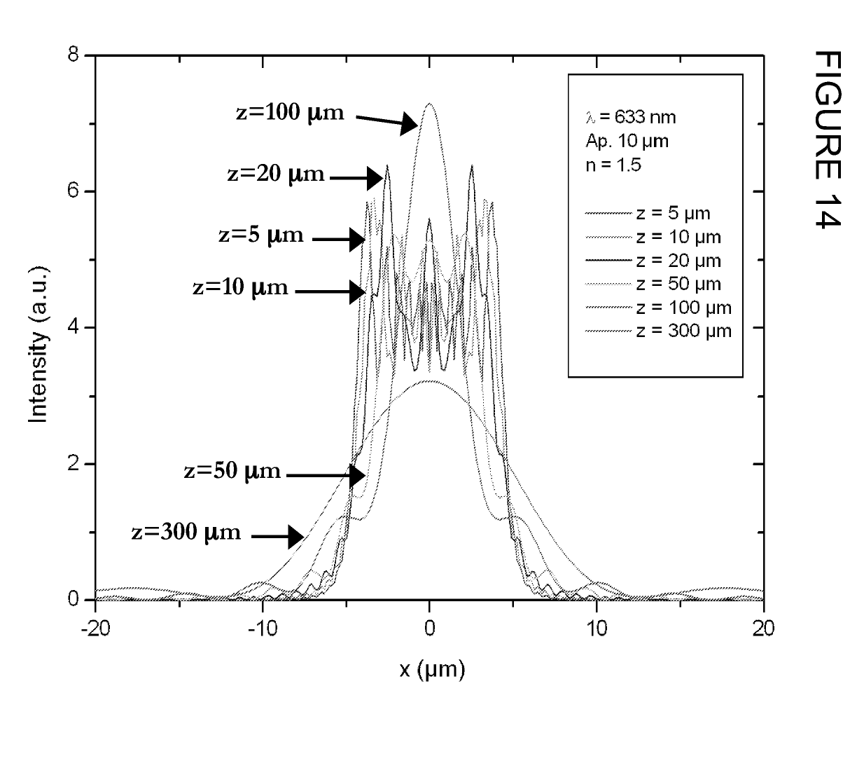

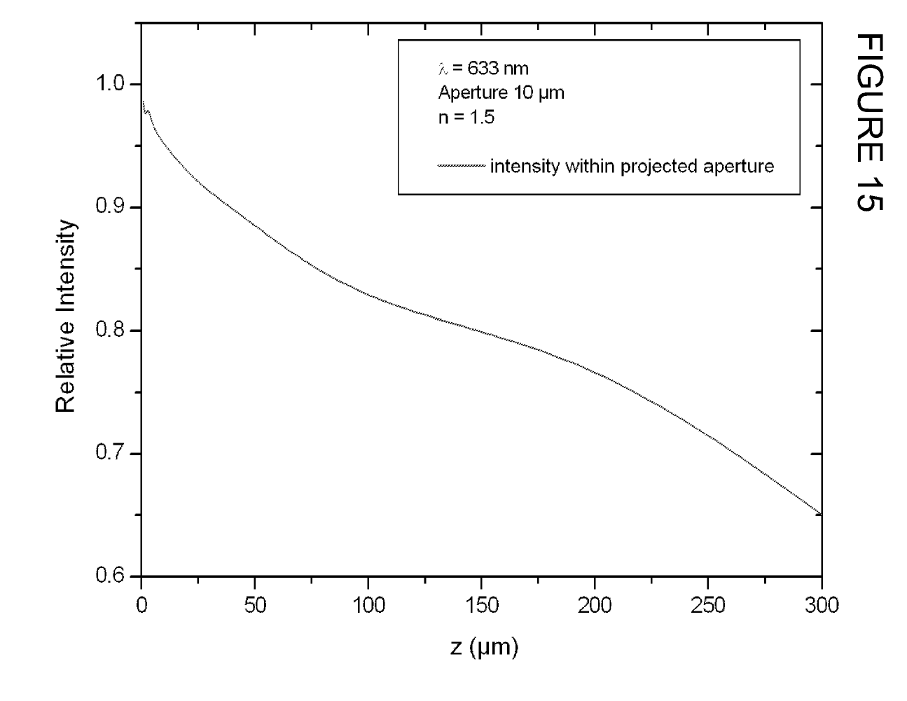

FIG. 14 shows Fresnel diffraction profiles calculated for diffraction from a slit 10 μm wide, for various distances from the slit, in a two dimensional model, where the dimensions are perpendicular to the slit (z), and transverse to the slit (x). The slit of uniform illumination is located between −5 μm and +5 μm on the x axis, with z equal to zero microns. The light transmitting medium is taken to have a refractive index of 1.5, which may be representative of media which would be used in a compact device. The light was taken to be red light with a vacuum wavelength of 633 nm. Green and blue wavelengths have shorter wavelengths than red light, hence the calculations for red light represent the strongest diffraction effects for the three colours red, green and blue. Calculations were performed using MathCad® software sold by Parametric Technology Corp., Needham, Mass., USA. FIG. 15 shows the fraction of the intensity which remains within a 10 μm width centred on the slit centre, as a function of distance from the slit. At a distance of 20 μm from the slit, FIG. 15 shows that greater than 90% of the intensity is still within the 10 μm width of the slit. Hence less than about 5% of the pixel intensity would be incident on each adjacent pixel, in this two dimensional model. This calculation is in the limiting case of zero boundary width between pixels. Real boundary widths between pixels are greater than zero, hence for a real system the cross-talk problem would be lower than calculated here. In FIG. 14 the Fresnel diffraction profiles close to the slit, such as at 50 μm from the slit, also approximate somewhat the top-hat intensity function at the slit. Hence there are not broad diffraction features close to the slit. Broad diffraction features are characteristic of the far-field diffraction function of the top-hat function, which is a sinc squared function, as known to those skilled in the art. Broad diffraction features are observed in FIG. 14 for the case of a 300 μm distance from the slit. This shows that diffraction effects can be controlled by placing the two MOSLMs in close enough proximity, and that an advantage of placing the two MOSLMs in close proximity is that the functional form of the diffraction profile changes from that characteristic of the far field to a functional form which is more effective at containing the light close to the axis perpendicular to the slit. This advantage is one which is counter to the mind set of those skilled in the art of holography, as those skilled in the art tend to expect strong, significant and unavoidable diffraction effects when light passes through the small apertures of an SLM. Hence one skilled in the art would not be motivated to place two SLMs close together, as one would expect this to lead to inevitable and serious problems with pixel cross-talk due to diffraction effects.

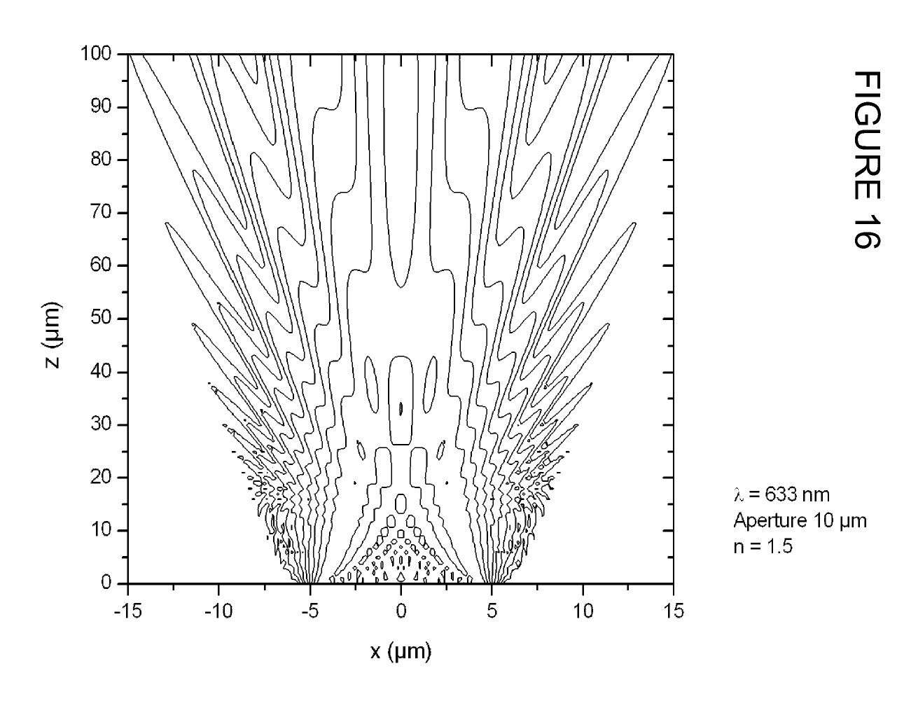

FIG. 16 shows a contour plot of the intensity distribution as a function of the distance from the slit. The contour lines are plotted on a logarithmic scale, not on a linear scale. Ten contour lines are used, which cover in total an intensity factor range of 100. The large degree of confinement of the intensity distribution to the 10 μm slit width for distances within about 50 μm from the slit is clear.

In a further implementation, the aperture area of the pixels in the first MOSLM may be reduced to reduce cross-talk problems at the second MOSLM.

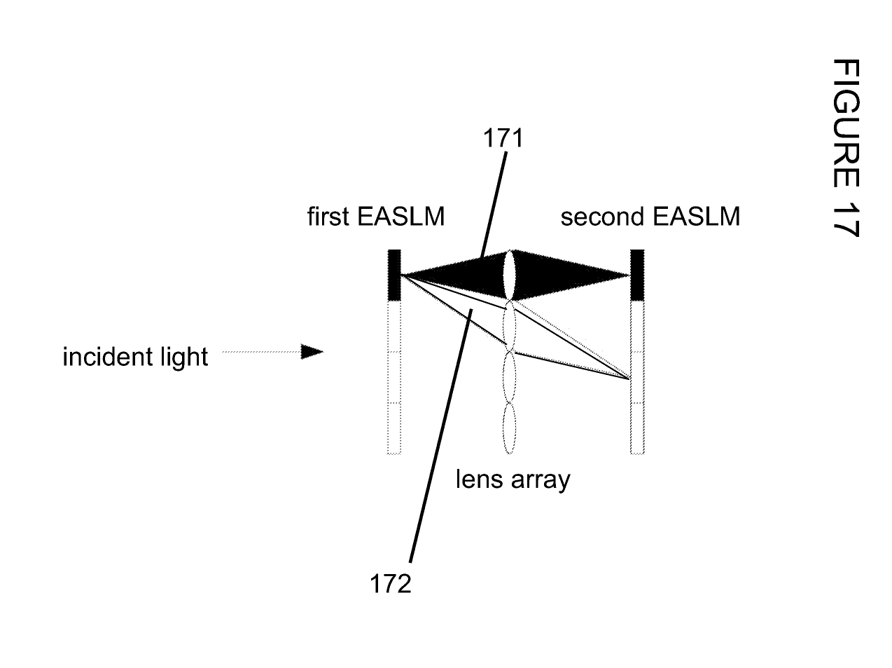

(2) A second approach uses a lens array between the two SLMs, as shown in FIG. 17. Preferably, the number of lenses is the same as the number of pixels in each SLM. The pitches of the two SLMs and of the lens array may be slightly different to compensate for the differences in the distance from the observer. Each lens images a pixel of the first SLM on the respective pixel of the second SLM, as shown by the bundle of light 171 in FIG. 17. There will also be light through the neighboring lens that may cause crosstalk, as shown by the bundle of light 172. This may be neglected if either its intensity is sufficiently low or its direction is sufficiently different so that it does not reach the VOW.

The numerical aperture (NA) of each lens has to be sufficiently large in order to image the pixel with sufficient resolution. As an example, for a resolution of 5 μm a NA≈0.2 is required. This means that if geometric optics is assumed, the maximum distance between the lens array and each SLM is about 25 μm if the pitch of the SLM and the lens array is 10 μm.

It is also possible to assign several pixels of each SLM to one lens of the lens array. As an example, a group of four pixels of the first SLM may be imaged to a group of four pixels of the second SLM by a lens of the lens array. The number of lenses of such a lens array would be a fourth of the number of pixels in each SLM. This allows a higher NA of the lenses and hence higher resolution of the imaged pixels.

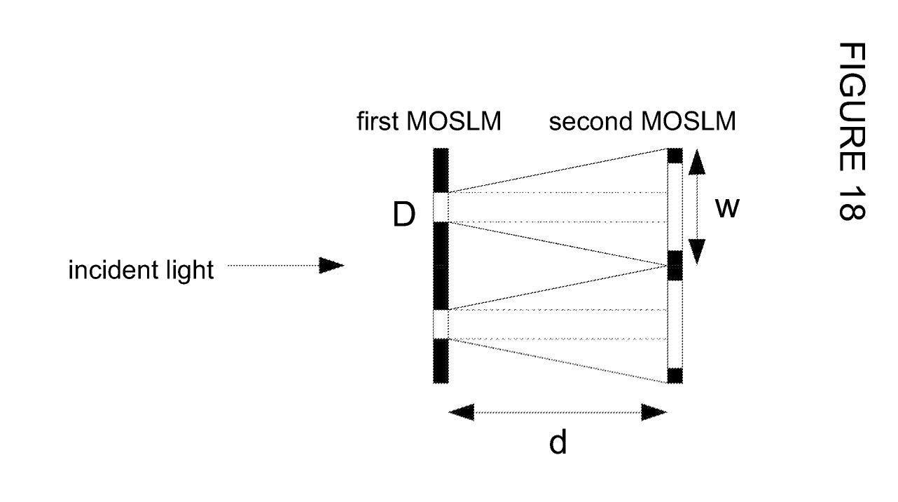

(3) A third approach is to reduce the aperture of the pixels of the first MOSLM as much as possible. From a diffraction point of view, the area of the second SLM that is illuminated by a pixel of the first SLM is determined by the aperture width D of the pixel of the first MOSLM and by the diffraction angle, as shown in FIG. 18. In FIG. 18, d is the distance between the two MOSLMs, and w is the distance between the two first order diffraction minima which occur either side of the zero order maximum. This is assuming Fraunhofer diffraction, or a reasonable approximation to Fraunhofer diffraction.

Reducing the aperture width D on the one hand reduces the directly projected area in the central part of the illuminated area, as indicated by the dotted lines in FIG. 18. On the other hand, the diffraction angle is increased, as the diffraction angle is proportional to 1/D in Fraunhofer diffraction. This increases the width w of the illuminated area on the second MOSLM. The illuminated area has the total width w. In a Fraunhofer diffraction regime, D may be determined such that it minimizes w at a given separation d, using the equation w=D+2dλ/D which is derived from the distance between the two first order minima in Fraunhofer diffraction.

For example, if λ is 0.5 μm, d is 100 μm and w is 20 μm, one obtains a minimum in D for D of 10 μm. While the Fraunhofer regime may not be a good approximation in this example, this example illustrates the principle of using the distance between the MOSLMs to control the diffraction process in the Fraunhofer diffraction regime.

(4) A fourth approach uses a fiber optic faceplate to image the pixels of the first SLM on the pixels of the second SLM. A fiber optic faceplate consists of a 2D arrangement of parallel optic fibers. The length of the fibers and hence the thickness of the faceplate is typically several millimeters and the length of the diagonal across the face of the plate is up to several inches. As an example, the pitch of the fibers may be 6 μm. Fibre optic faceplates with such a fibre pitch are sold by Edmund Optics Inc. of Barrington, N.J., USA. Each fiber guides light from one of its ends to the other end. Therefore, an image on one side of the faceplate is transferred to the other side, with high resolution and without focusing elements. Such a faceplate may be used as a separating layer between the two SLMs. Multimode fibres are preferred over single mode fibres, because multimode fibres have better coupling efficiency than single mode fibres. Coupling efficiency is optimal when the refractive index of the core of the fibre is matched to the refractive index of the liquid crystal, as this minimizes Fresnel back reflection losses.

There are no additional cover glasses between the two SLMs. The light that has passed through a pixel of the first MOSLM is guided to the respective pixel of the second MOSLM. This minimizes crosstalk to the neighboring pixels. The faceplate transfers the light distribution at the output of the first SLM to the input of the second SLM. On average there should be at least one fibre per pixel. If there is less than one fibre per pixel, on average, SLM resolution will be lost, which will reduce the quality of the image shown in an application in a holographic display.

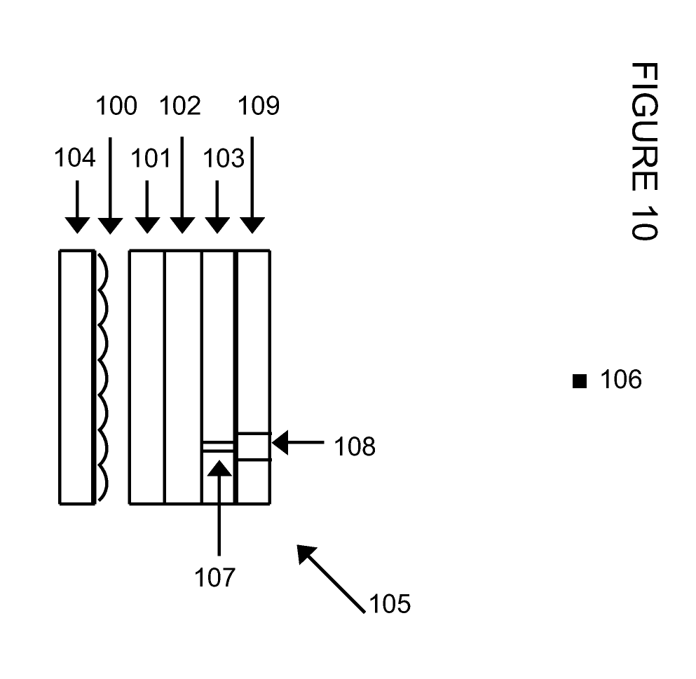

An example of a compact arrangement for encoding amplitude and phase information in a hologram is disclosed in FIG. 10. 104 is an illumination apparatus for providing illumination of a plane area, where the illumination has sufficient coherence so as to be able to lead to the generation of a three dimensional image. An example of an illumination apparatus is disclosed in US 2006/250671 for the case of large area video holograms. Such an apparatus as 104 may take the form of an array of white light sources, such as cold cathode fluorescent lamps or white light light emitting diodes which emit light which is incident on a focusing system which may be compact such as a lenticular array or a microlens array 100. Alternatively, light sources for 104 may comprise of red, green and blue lasers or red, green and blue light emitting diodes which emit light of sufficient coherence. However, non-laser sources with sufficient spatial coherence (eg. light emitting diodes, OLEDs, cold cathode fluorescent lamps) are preferred to laser sources. Laser sources have disadvantages such as causing laser speckle in the holographic reconstructions, being relatively expensive, and having possible safety problems with regard to possibly damaging the eyes of holographic display viewers or of those who work in assembling the holographic display devices.

Elements 104, 100-103, 109 may be about a few centimetres in thickness, or less, in total. Element 101 may comprise of an array of colour filters, such that pixels of colour light, such as red, green and blue light, are emitted towards element 102, although the colour filters may not be required if coloured sources of light are used. Element 102 is a light polarizing element, or a set of light polarizing elements. Element 103 is an MOSLM which encodes phase information. Element 109 is an MOSLM which encodes amplitude information. Elements 103 and 109 each contain a polarizing element or a set of polarizing elements. Each cell in element 103, represented here by 107, is aligned with a corresponding cell in element 109, represented here by 108. However, although the cells in elements 103 and 109 have the same lateral spacing, or pitch, the cells in element 103 are smaller than or the same size as the cells in element 109, because light exiting cell 107 may typically undergo some diffraction before entering cell 108 in element 109. The order in which amplitude and phase are encoded may be reversed from that shown in FIG. 10.

A viewer located at point 106 some distance from the device which includes the compact hologram generator 105 may view a three dimensional image when viewing in the direction of 105. Elements 104, 100, 101, 102, 103 and 109 are arranged so as to be in physical contact as described above, so as to form a compact hologram generator 105. Optical components described in section B may be included in compact hologram generator 105, as would be obvious to one skilled in the art.

E. Large Magnification Three Dimensional Image Display Device Component Incorporating the Compact Combination of One or Two MOSLMs, with Holographic Reconstruction of the Object

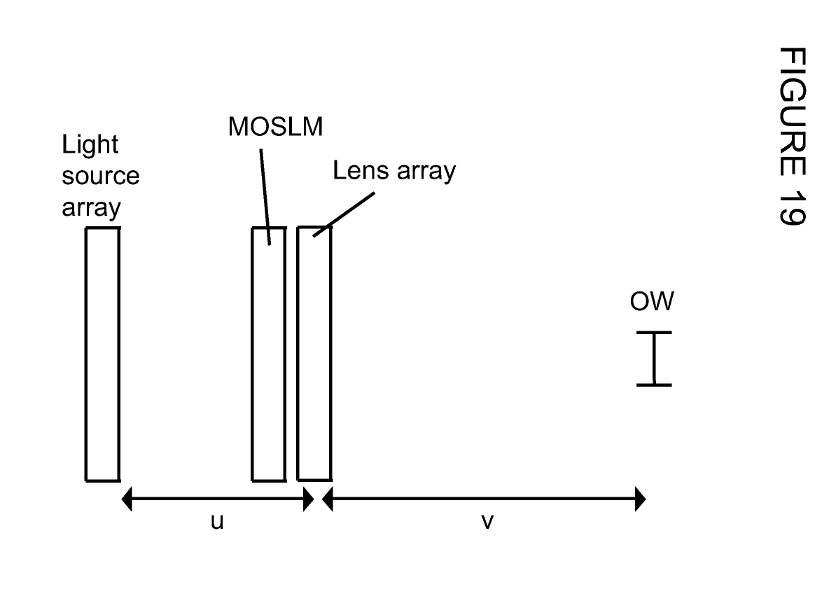

A large magnification three dimensional image display device component incorporating the compact combination of one or two MOSLMs, with holographic reconstruction of the object, is shown in FIG. 19. The device component includes a compact combination of an MOSLM and a compact light source of sufficient coherence, the combination being capable of generating a three dimensional image viewable in an VOW (denoted OW in FIG. 19) under suitable illumination conditions, where the device component may be incorporated in a PDA or in a mobile phone, for example. The compact combination of an SLM and a compact light source of sufficient coherence comprises an array of light sources, an SLM and a lens array, as shown in FIG. 19. The SLM in FIG. 19 incorporates the compact combination of one or two MOSLMs.

In a simple example, an array of light sources may be formed as follows. A single light source such as a monochromatic LED is placed next to an array of apertures such that the apertures are illuminated. If the apertures are a one dimensional array of slits, the light transmitted by the slits forms a one dimensional array of light sources. If the apertures are a two dimensional array of circles, the illuminated set of circles forms a two dimensional array of light sources. A typical aperture width will be about 20 μm. Such an array of light sources is suitable for contributing to the generation of a VW for one eye.

In FIG. 19, the array of light sources is situated at a distance u from the lens array. The array of light sources may be the light sources of element 10 of FIG. 1, and may optionally incorporate element 12 of FIG. 1. To be precise, each source of light in the light source array is situated at a distance u from its corresponding lens in the lens array. The planes of the light source array and of the lens array are parallel in a preferred implementation. The SLM may be located at either side of the lens array. The VOW is at a distance v from the lens array. The lenses in the lens array are converging lenses with a focal length f given by f=1/[1/u+1/v]. In a preferred implementation, v is in the range of 300 mm to 600 mm. In a particularly preferred implementation v is about 400 mm. In a preferred implementation u is in the range of 10 mm to 30 mm. In a particularly preferred implementation u is about 20 mm. The magnification factor M is given by v/u. M is the factor by which the light sources, which have been modulated by the SLM, are magnified at the VOW. In a preferred implementation, M is in the range of 10 to 60. In a particularly preferred implementation, M is about 20. To achieve such magnification factors with good holographic image quality requires accurate alignment of the light source array and the lens array. Significant mechanical stability of the device component is required, in order to maintain this accurate alignment, and to maintain the same distance between the light source array and the lens array, over the operating lifetime of the component.

The VOW may be trackable or non-trackable. If the VOW is trackable, then depending on the required position of the VOW, specific light sources in the array of light sources are activated. The activated light sources illuminate the SLM and are imaged into the observer plane by the lens array. At least one light source per lens of the lens array is activated in the light source array. The tracking is quasi-continuous. If u is 20 mm and v is 400 mm, the VOW can be tracked with a lateral increment of 400 μm if the pixel pitch is 20 μm. This tracking is quasi-continuous. If u is 20 mm and v is 400 mm, f is approximately 19 mm.

The light sources in the light source array may have only partial spatial coherence. Partial coherence leads to a smeared reconstruction of the object points. If u is 20 mm and v is 400 mm, an object point at a distance of 100 mm from the display is reconstructed with a lateral smearing of 100 μm if the light source width is 20 μm. This is sufficient for the resolution of the human vision system.

There does not have to be any significant mutual coherence between the light that passes through different lenses of the lens array. The coherence requirement is limited to each single lens of the lens array. Therefore, the resolution of a reconstructed object point is determined by the pitch of the lens array. A typical lens pitch will be of the order of 1 mm to guarantee sufficient resolution for the human vision system.

The VOW is limited to one diffraction order of the Fourier spectrum of the information encoded in the SLM. At a wavelength of 500 nm the VOW has a width of 10 mm if the pixel pitch of the SLM is 20 μm. The VOW may be enlarged by tiling of VOWs by spatial or temporal multiplexing. In the case of spatial multiplexing additional optical elements such as beam splitters are required.

Color holographic reconstructions can be achieved by temporal multiplexing. The red, green and blue pixels of a color OLED display are sequentially activated with synchronous re-encoding of the SLM with holograms calculated for red, green and blue optical wavelengths.

The display of which the device component forms a part may comprise an eye position detector that detects the positions of the observer's eyes. The eye position detector is connected with a control unit that controls the activation of the light sources within the array of light sources.

The calculation of the holograms that are encoded on the SLM is preferably performed in an external encoding unit as it requires high computational power. The display data are then sent to the PDA or mobile phone to enable the display of a holographically-generated three dimensional image.

F. 2D-Projector which Incorporates the Compact Combination of One or Two Pairs of MOSLMs

Instead of projecting the light into a number of VOWs, the light from a holographic display device may also be projected onto a screen or a wall or some other surface. Thus the three dimensional display device in a mobile phone or PDA can also be used as a pocket projector. Any other three dimensional display device which incorporates the compact combination of one or two pairs of MOSLMs may also be used as a projector.

An improved quality of holographic projection may be obtained by using a SLM that modulates the amplitude and the phase of the incident light. Thus a complex-valued hologram can be encoded on the SLM, which may result in a better quality of the image reconstructed on the screen or wall.

The compact combination of one or two pairs of MOSLMs, can be used as a SLM in a projector. Due to the compact size of the combination, the projector may also be compact. The projector can even be the same device as the mobile phone or the PDA: it may be switched between the modes “three dimensional display” and “projector”.

Compared to conventional 2D projectors, a holographic 2D projector has the advantage that no projection lenses are needed and that the projected image is focused at all distances in the optical far field. Prior art holographic 2D projectors, such as disclosed in WO2005/059881, use a single SLM that is therefore not capable of complex modulation. The holographic 2D projector disclosed here would be capable of complex modulation and would therefore have superior image quality.

### G. Spatial Multiplexing of Observer Windows and 2D-Encoding

This implementation relates to spatial multiplexing of virtual observer windows (VOWs) of a holographic display combined with using 2D-encoding. Otherwise, the holographic display may be as described in sections A, B, C or D, or it may be any known holographic display.

It is known that several VOWs, e.g. one VOW for the left eye and one VOW for the right eye, can be generated by spatial or temporal multiplexing. For spatial multiplexing, both VOWs are generated at the same time and are separated by a beam splitter, similar to an autostereoscopic display, as described in WO 2006/027228, which is incorporated herein by reference. For temporal multiplexing, the VOWs are generated time sequentially.

However, known holographic display systems suffer some disadvantages. For spatial multiplexing an illumination system has been used that is spatially incoherent in the horizontal direction and which is based on horizontal line light sources and a lenticular array, as shown for example in prior art FIG. 4, which is taken from WO 2006/027228. This has the advantage that the techniques known from autostereoscopic displays can be used. However, there is the disadvantage that a holographic reconstruction in the horizontal direction is not possible. Instead, a so-called 1D-encoding is used that leads to holographic reconstruction and motion parallax only in the vertical direction. Hence, the vertical focal point is in the plane of the reconstructed object, whereas the horizontal focal point is in the plane of the SLM. This astigmatism reduces the quality of spatial vision i.e. it reduces the quality of the holographic reconstruction which is perceived by a viewer. Similarly, temporal multiplexing systems suffer a disadvantage in that they require fast SLMs which are not yet available in all display sizes, and which even if available may be prohibitively expensive.

Only 2D-encoding provides holographic reconstruction simultaneously in the horizontal and the vertical directions and hence 2D-encoding produces no astigmatism, where astigmatism leads to a reduced quality of spatial vision i.e. to a reduced quality of the holographic reconstruction which is perceived by a viewer. It is therefore an object of this implementation to achieve spatial multiplexing of VOWs in combination with 2D-encoding.

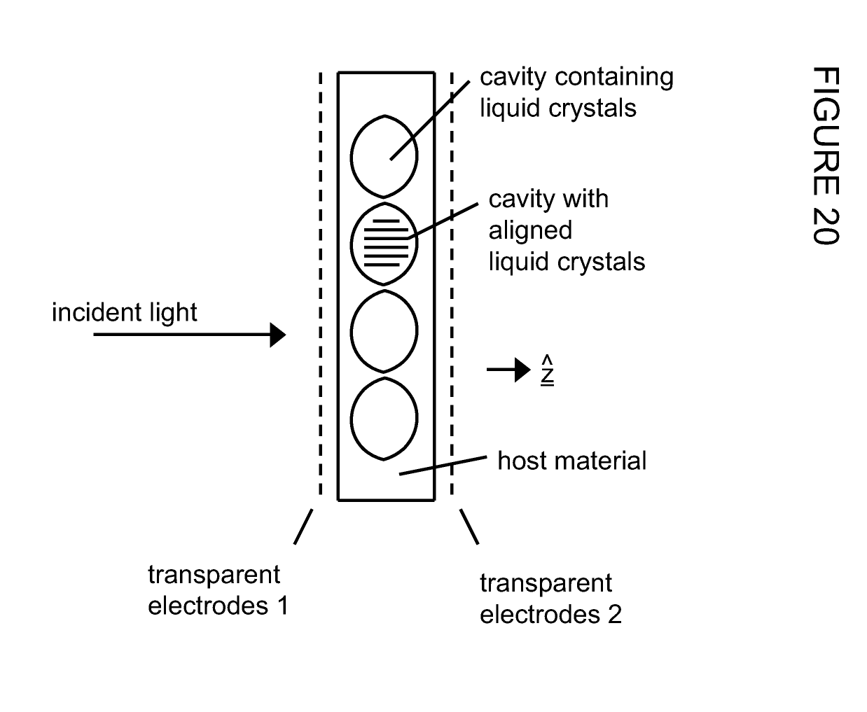

In this implementation, illumination with horizontal and vertical local spatial coherence is combined with a beam splitter that separates the light into bundles of rays for the left eye VOW and for the right eye VOW. Thereby the diffraction at the beam splitter is taken into account. The beam splitter may be a prism array, a second lens array (eg. a static array, or a variable array eg. one as shown in FIG. 20) or a barrier mask.

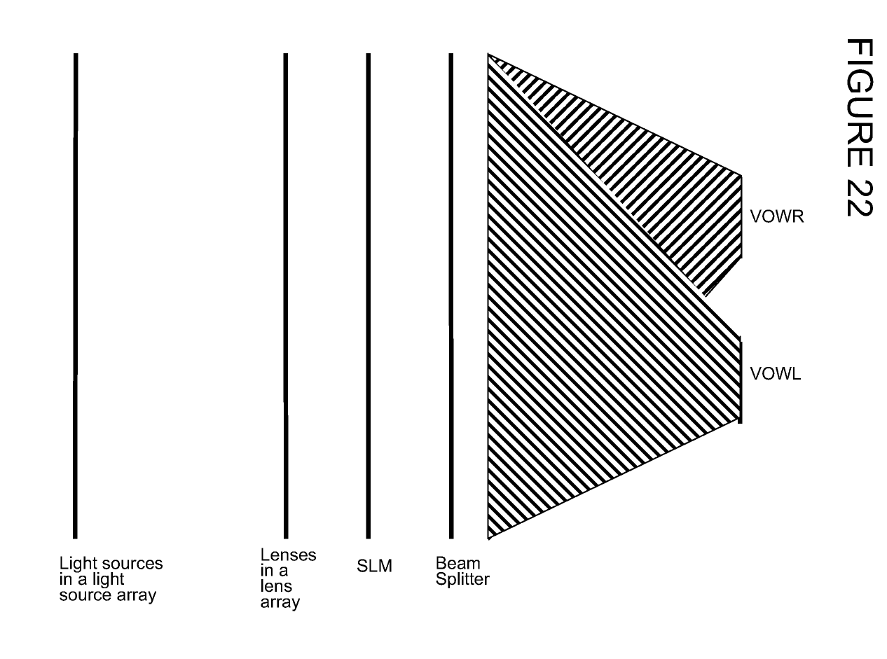

An example of this implementation is shown in FIG. 22. FIG. 22 is a schematic drawing of a holographic display comprising light sources in a 2D light source array, lenses in a 2D lens array, a SLM and a beamsplitter. The beamsplitter splits the rays leaving the SLM into two bundles each of which illuminates the virtual observer window for the left eye (VOWL) and the virtual observer window for the right eye (VOWR), respectively. In this example, the number of light sources is one or more; the number of lenses equals the number of light sources.

In this example the beamsplitter is after the SLM. The positions of beamsplitter and SLM may also be swapped.

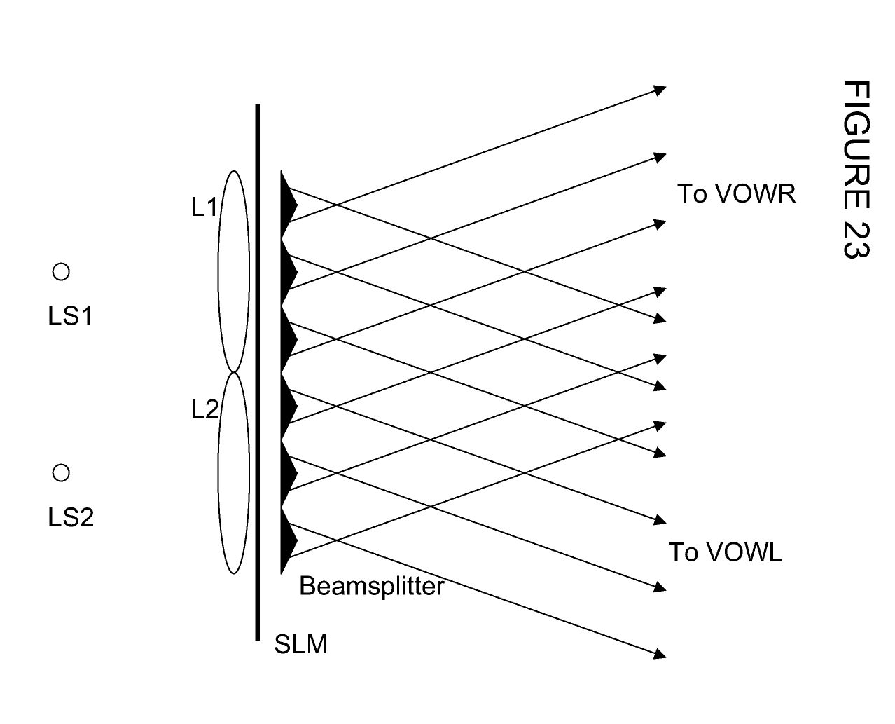

An example of this implementation is shown in FIG. 23, in plan view, in which a prism array is used as a beam splitter. The illumination comprises an n element 2D light-source array (LS1, LS2, . . . LSn) and an n element 2D lens array (L1, L2, . . . Ln), of which only two light sources and two lenses are shown in FIG. 23. Each light source is imaged to the observer plane by its associated lens. The pitch of the light source array and the pitch of the lens array are such that all light-source images coincide in the observer plane i.e. the plane which contains the two VOWs. In FIG. 23, the left eye VOW (VOWL) and the right eye VOW (VOWR) are not shown in the Figure, because they are located outside the Figure, to the right of the Figure. An additional field lens may be added. The pitch of the lens array is similar to the typical size of a sub-hologram in order to provide sufficient spatial coherence, i.e. the order of from one to several millimeters. The illumination is horizontally and vertically spatially coherent within each lens, as the light sources are small or point light sources and as a 2D lens array is used. The lens array may be refractive, diffractive or holographic.

In this example, the beamsplitter is a 1D array of vertical prisms. The light incident on one slope of a prism is deflected to the left eye VOW (to VOWL), the light incident on the other slope of the prism is deflected to the right eye VOW (to VOWR). The rays that originate from the same LS and the same lens are also mutually coherent after passing through the beamsplitter. Hence, a 2D-encoding with vertical and horizontal focusing and vertical and horizontal motion parallax is possible.

The hologram is encoded on the SLM with 2D-encoding. The holograms for the left and the right eye are interlaced column by column, i.e. there are alternating columns encoded with left eye and right eye hologram information. Preferably, under each prism there is column with a left eye hologram information and a column with a right eye hologram information. As an alternative, there may also be two or more columns of a hologram under each slope of the prism, e.g. three columns for VOWL followed by three columns for VOWR, in succession. The pitch of the beam splitter may be the same as, or an integer (such as two or three) multiple of, the pitch of the SLM, or the pitch of the beam splitter may be slightly smaller than, or slightly smaller than an integer (such as two or three) multiple of, the pitch of the SLM in order to accommodate perspective shortening.

Light from the columns with the left eye hologram reconstructs the object for the left eye and illuminates the left eye VOW (VOWL); the light from the columns with the right eye hologram reconstructs the object for the right eye and illuminates the right eye VOW (VOWR). Thus each eye perceives the appropriate reconstruction. If the pitch of the prism array is sufficiently small, the eye cannot resolve the prism structure and the prism structure does not disturb the reconstructed image. Each eye sees a reconstruction with full focusing and full motion parallax, and there is no astigmatism.

There will be diffraction at the beamsplitter as the beamsplitter is illuminated with coherent light. The beamsplitter may be regarded as a diffraction grating that generates multiple diffraction orders. The slanted prism slopes have the effect of a blazed grating. At a blazed grating, the maximum of the intensity is directed to a specific diffraction order. At a prism array, one maximum of the intensity is directed from one slope of the prisms to a diffraction order at the position of VOWL, and another maximum of intensity is directed from the other slope of the prisms to another diffraction order at the position of VOWR. To be more precise, the maxima in the intensities of the enveloping sinc-squared functions are shifted to these positions, whereas the diffraction orders are at fixed positions. The prism array generates one intensity enveloping sinc-squared function maximum at the position of VOWL and another intensity enveloping sinc-squared function maximum at the position of VOWR. The intensity of other diffraction orders will be small (i.e. the sinc squared intensity function maximum is narrow) and will not lead to a disturbing crosstalk as the fill factor of the prism array is large, e.g. close to 100%.

As will be obvious to one skilled in the art, by using a more complex array of prisms (eg. two types of prism with the same apex angles but different degrees of asymmetry, disposed adjacent each other, in succession) one may generate more VOWs, in order to provide VOWs for two observers, or for more than two observers. However, the observers cannot be tracked individually with a static array of prisms.

In a further example, one may use more than one light source per lens. Additional light sources per lens can be used to generate additional VOWs for additional observers. This is described in WO 2004/044659 (US2006/0055994), for the case of one lens and m light sources for m observers. In this further example, m light sources per lens and twofold spatial multiplexing are used to generate m left VOWs and m right VOWs for m observers. The m light sources per lens are in m-to-one correspondence with each lens, where m is a whole number.

Here is an example of this implementation. A 20 inch screen diagonal is used, with the following parameters: observer distance 2 m, pixel pitch 69 μm in the vertical by 207 μm in the horizontal, Burckhardt encoding is used, and the optical wavelength is 633 nm. The Burckhardt encoding is in the vertical direction with a subpixel pitch of 69 μm and a VOW height of 6 mm (vertical period). Neglecting the perspective shortening, the pitch of the array of vertical prisms is 414 μm, i.e. there are two columns of the SLM under each full prism. The horizontal period in the observer plane is therefore 3 mm. This is also the width of the VOW. This width is smaller than optimal for an eye pupil of ca. 4 mm in diameter. In a further but similar example, if the SLM has a smaller pitch of 50 μm the VOW would have a width of 25 mm.

If a human adult has an eye separation of 65 mm (as is typical), the prisms have to deflect the light by ±32.5 mm where the light intersects the plane containing the VOWs. To be more precise, the intensity enveloping sinc-squared function maxima have to be deflected by ±32.5 mm. This corresponds to an angle of ±0.93° for 2 m observer distance. The appropriate prism angle is ±1.86° for a prism refractive index n=1.5. The prism angle is defined as the angle between the substrate and the sloping side of a prism.

For a horizontal period in the observer plane of 3 mm, the other eye is at a distance of about 21 diffraction orders (i.e. 65 mm divided by 3 mm). The crosstalk in VOWL and in VOWR caused by higher diffraction orders related to the other VOW is therefore negligible.

In order to implement tracking, a simple way of tracking is light-source tracking, i.e. adapting the light-source position. If SLM and prism array are not in the same plane, there will be a disturbing relative lateral offset between the SLM pixels and the prisms, caused by the parallax. This may lead to disturbing crosstalk. The pixels of the 20 inch screen diagonal example above may have a fill factor of 70% in the direction perpendicular to the axes described by the peak of each of the prisms, i.e. the pixel dimensions are 145 μm active area and 31 μm inactive margin on each side. If the structured area of the prism array is directed towards the SLM, the separation between prism array and SLM may be ca. 1 mm. The horizontal tracking range without crosstalk would be ±31 μm/1 mm*2 m=±62 mm. The tracking range would be larger if a small crosstalk were tolerated. This tracking range is not large but it is sufficient to permit some tracking to take place, so that the viewer will be less constrained as to where to position his/her eyes.

The parallax between SLM and prism array can be avoided, preferably by integration of the prism array in or directly on the SLM (as a refractive, diffractive, or holographic prism array). This would be a specialized component for a product. An alternative is lateral mechanical movement of the prism array, though this is not preferred as moving mechanical parts would complicate the apparatus.

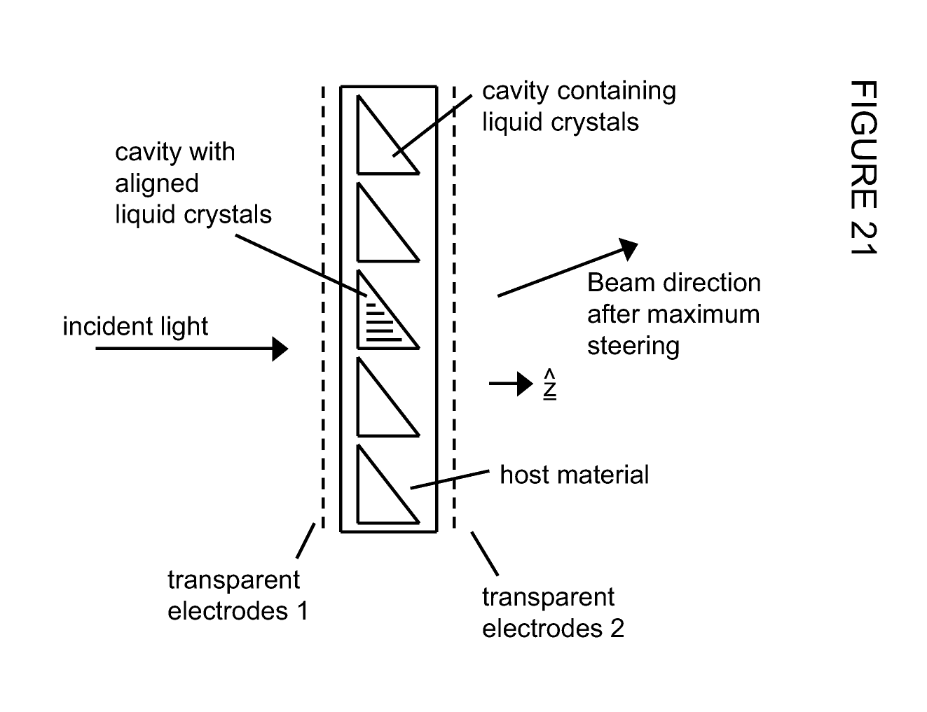

Another critical issue is the fixed separation of the VOWs which is given by the prism angle. This may lead to complications for observers with non-standard eye separation or for z-tracking. As a solution, an assembly including encapsulated liquid-crystal domains may be used, such as that shown in FIG. 21. An electric field may then control the refractive index and hence the deflection angle. This solution may be incorporated with a prism array, so as to give a variable deflection and a fixed deflection, respectively, in succession. In an alternative solution, the structured side of the prism array might be covered by a liquid-crystal layer. An electric field might then control the refractive index and hence the deflection angle. A variable deflection assembly is not necessary if the VOWs have such a large width that there is sufficient tolerance for observers with different eye separations and for z-tracking.

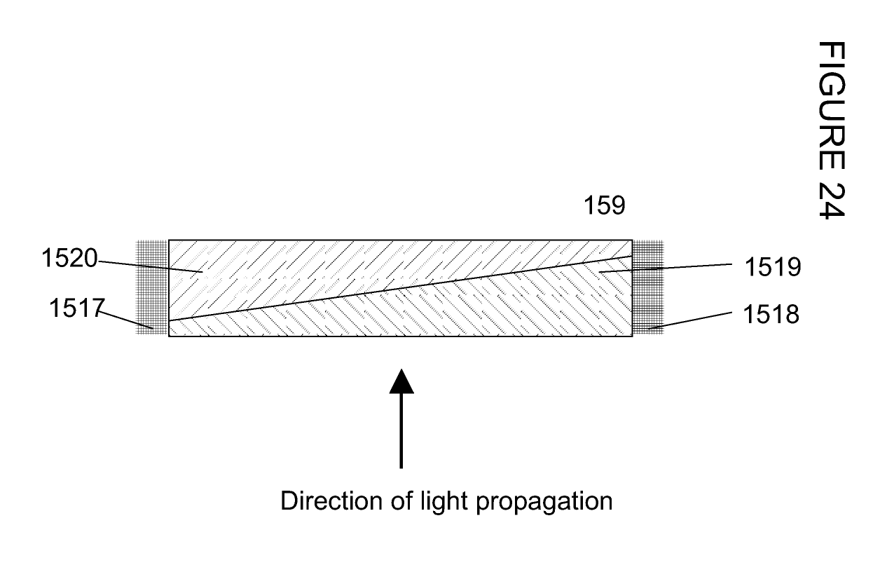

A more complex solution would be to use controllable prism arrays, e.g. e-wetting prism arrays (as shown in FIG. 24) or prisms filled with liquid crystals (as shown in FIG. 21). In FIG. 24, the layer with the prism element 159 comprises electrodes 1517, 1518 and a cavity filled with two separate liquids 1519, 1520. Each liquid fills a prism-shaped part of the cavity. As an example, the liquids may be oil and water. The slope of the interface between the liquids 1519, 1520 depends on the voltage applied to the electrodes 1517, 1518. If the liquids have different refractive indices the light beam will experience a deviation that depends on the voltage applied to the electrodes 1517, 1518. Hence the prism element 159 acts as a controllable beam steering element. This is an important feature for the applicant's approach to electro-holography for implementations which require tracking of VOWs to the observers' eyes. Patent applications DE 102007024237.0, DE 102007024236.2 filed by the applicant, which are incorporated herein by reference, describe tracking of VOWs to the observers' eyes with prism elements.

Here is an example of the implementation for use in a compact hand-held display. Seiko® Epson® Corporation of Japan has released monochrome EASLMs, such as the D4:L3D13U 1.3 inch screen diagonal panel. An example is described using the D4:L3D13U LCD panel as the SLM. It has HDTV resolution (1920 by 1080 pixels), 15 μm pixel pitch and a panel area of 28.8 mm by 16.2 mm. This panel is usually used for 2D image projection displays.

The example is calculated for a wavelength of 633 nm and an observer distance of 50 cm. Detour-phase encoding (Burckhardt encoding) is used for this amplitude-modulating SLM: three pixels are needed to encode one complex number. These three associated pixels are vertically arranged. If the prism-array beamsplitter is integrated in the SLM, the pitch of the prism array is 30 μm. If there is a separation between SLM and prism array, the pitch of the prism array is slightly different to account for the perspective shortening.

The height of a VOW is determined by the pitch of 3*15 μm=45 μm to encode one complex number and is 7.0 mm. The width of the VOW is determined by the 30 μm pitch of the prism array and is 10.6 mm. Both values are larger than the eye pupil. Therefore, each eye can see a holographic reconstruction if the VOWs are located at the eyes. The holographic reconstructions are from 2D-encoded holograms and hence are without the astigmatism inherent in 1D-encoding, described above. This ensures high quality of spatial vision and high quality of depth impression.

As the eye separation is 65 mm, the prisms have to deflect the light by ±32.5 mm. To be more precise, the intensity maxima of the enveloping sinc-squared intensity functions have to be deflected by ±32.5 mm. This corresponds to an angle of ±3.72° for 0.5 m observer distance. The appropriate prism angle is ±7.44° for a refractive index n=1.5. The prism angle is defined as the angle between substrate and the sloping side of a prism.

For a horizontal period in the observer plane of 10.6 mm the other eye is at a distance of ca. 6 diffraction orders (i.e. 65 mm divided by 10.6 mm). The crosstalk caused by higher diffraction orders is therefore negligible as the prism array has a high fill factor i.e. close to 100%.

Here is an example of the implementation for use in a large display. A holographic display may be designed using a phase-modulating SLM with a pixel pitch of 50 μm and a screen diagonal of 20 inches. For application as a TV the diagonal might rather be approximately 40 inches. The observer distance for this design is 2 m and the wavelength is 633 nm.

Two phase-modulating pixels of the SLM are used to encode one complex number. These two associated pixels are vertically arranged and the corresponding vertical pitch is 2*50 μm=100 μm. With a prism array integrated in the SLM, the horizontal pitch of the prism array is also 2*50 μm=100 μm as each prism comprises two slopes and each slope is for one column of the SLM. The resulting width and height of a VOW of 12.7 mm is larger than the eye pupil. Therefore, each eye can see a holographic reconstruction if the VOWs are located at the eyes. The holographic reconstructions are from 2D-encoded holograms and hence are without the astigmatism inherent in 1D-encoding. This ensures high quality of spatial vision and high quality of depth impression.

As the eye separation is 65 mm, the prisms have to deflect the light by ±32.5 mm. To be more precise, the maxima in the intensity enveloping sinc-squared functions have to be deflected by ±32.5 mm. This corresponds to an angle of ±0.93° for 2 m observer distance. The appropriate prism angle is ±1.86° for a refractive index n=1.5. The prism angle is defined as the angle between the substrate and the sloping side of a prism.

The above examples are for distances of the observer from the SLM of 50 cm and 2 m. More generally, the implementation may be applied for distances of the observer from the SLM of between 20 cm and 4 m. The screen diagonal may be between 1 cm (such as for a mobile phone sub-display) and 50 inches (such as for a large size television).

### Laser Light Sources

RGB solid state laser light sources, e.g. based on GaInAs or GaInAsN materials, may be suitable light sources for the compact holographic display because of their compactness and their high degree of light directionality. Such sources include the RGB vertical cavity surface emitting lasers (VCSEL) manufactured by Novalux® Inc., CA, USA. Such sources may be supplied as single lasers or as arrays of lasers, although each source can be used to generate multiple beams through the use of diffractive optical elements. The beams may be passed down multimode optical fibres as this may reduce the coherence level if the coherence is too high for use in compact holographic displays without leading to unwanted artefacts such as laser speckle patterns. Arrays of laser sources may be one dimensional or two dimensional.

### Outline Manufacturing Process

The following describes the outline of a process for manufacturing the device of FIG. 2, but many variations of this process will be obvious to those skilled in the art.

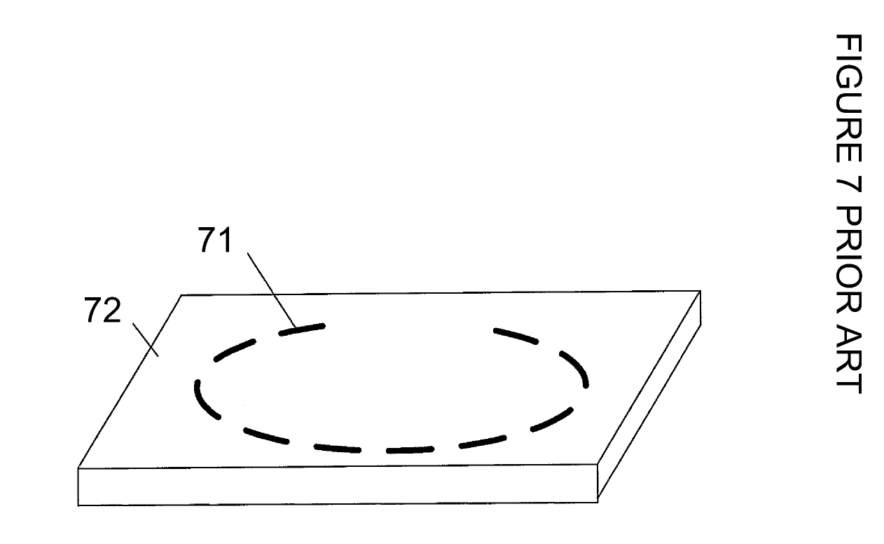

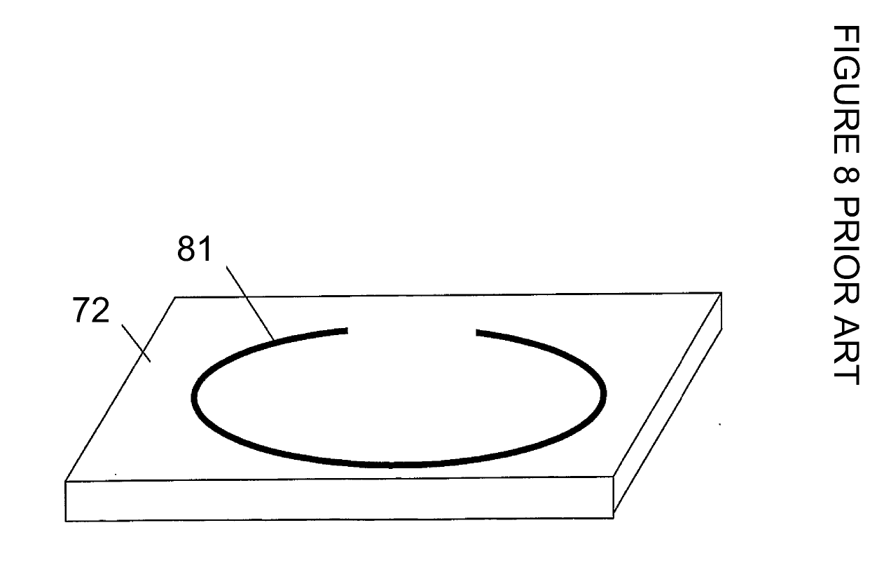

In a process for manufacturing the device of FIG. 2, a transparent substrate is selected. Such a substrate may be a rigid substrate such as a sheet of borosilicate glass which is about 200 μm thick, or it may be a flexible substrate such as a polymer substrate, such as a polycarbonate, acrylic, polypropylene, polyurethane, polystyrene, polyvinyl chloride or the like substrate. A CIAD layer is prepared on the glass, as described in patent application numbers GB 0709376.8, GB 0709379.2 by the applicant, which are incorporated herein by reference. Such computing circuitry may be disposed between the pixels of the display. The circuitry is then covered with a transparent insulating film, such as SiO₂. A magneto optical film is deposited on the transparent insulating film. A micro coil array is deposited, commensurate with the pixels of the display. A similar process is described in WO2005/122479A2. The coil material may be of any conductive material, such as Cu or Al. The coil array can be fabricated so as to have a low resistance and a large number of turns. A cylindrical groove 71, equal to the depth of the magneto optical film 72, is etched into the magneto optical film, as shown in FIG. 7. A conductive material is deposited into the cylindrical groove 71, to realize the micro-coil 81, as shown in FIG. 8. It should be noted that the groove can be realized by laser etching. Ultra-short pulsed laser pulses with pico- or femto-second duration pulse duration and high peak power can limit the heat affected zone and make the material removal process dominated by ablation, thus achieving excellent accuracy in magneto-optical films. An intermediate polarization layer or set of layers is then fabricated. This is followed by a further magneto optical film, on which a further micro coil array is fabricated as described above. A further polarization layer or set of layers follows. This completes the two adjacent MOSLM device structures. This is followed by the optional beam steering element, and a glass cover layer.

It may be necessary for the layers between the two MOSLM devices to be sufficiently thick so as to ensure that the magnetic fields present in one MOSLM do not affect the performance of the other MOSLM. The intermediate polarizer layer or set of layers may be thick enough to achieve this objective. However, if the intermediate polarizer layer or set of layers is of insufficient thickness, the layer thickness may be increased such as by bonding the MOSLM device using an optical adhesive to a sheet of glass of sufficient thickness, or by depositing a further optically transparent layer such as an inorganic layer or a polymer layer. Such a further optically transparent layer may be an inorganic insulator layer such as silicon dioxide, silicon nitride, or silicon carbide, or it may be a polymerizable layer such as an epoxy. Deposition could be performed by sputtering or by chemical vapour deposition in the case of the inorganic insulator layer, or it could be by printing or coating in the case of a polymerizable layer. The MOSLM devices must however not be too far apart so that optical diffraction effects lead detrimentally to pixel cross talk. For example, if the pixel width is 10 micrometres it is preferable that the MOSLM layers should be less than 100 micrometres apart. One MOSLM is configured to perform at least amplitude modulation; the other MOSLM is configured to perform at least phase modulation.

The second MOSLM part of the device may be prepared as a single unit which is then bonded onto the first MOSLM part of the device, using for example a glass layer which is present for example to ensure sufficient separation between the MOSLM layers that the magnetic fields present in each MOSLM do not influence the operation of the other MOSLM. Where the second MOSLM part of the device is prepared by depositing further material on the first MOSLM part of the device, this may have the advantage that precision alignment of the pixels of the second MOSLM with the pixels of the first MOSLM is facilitated.

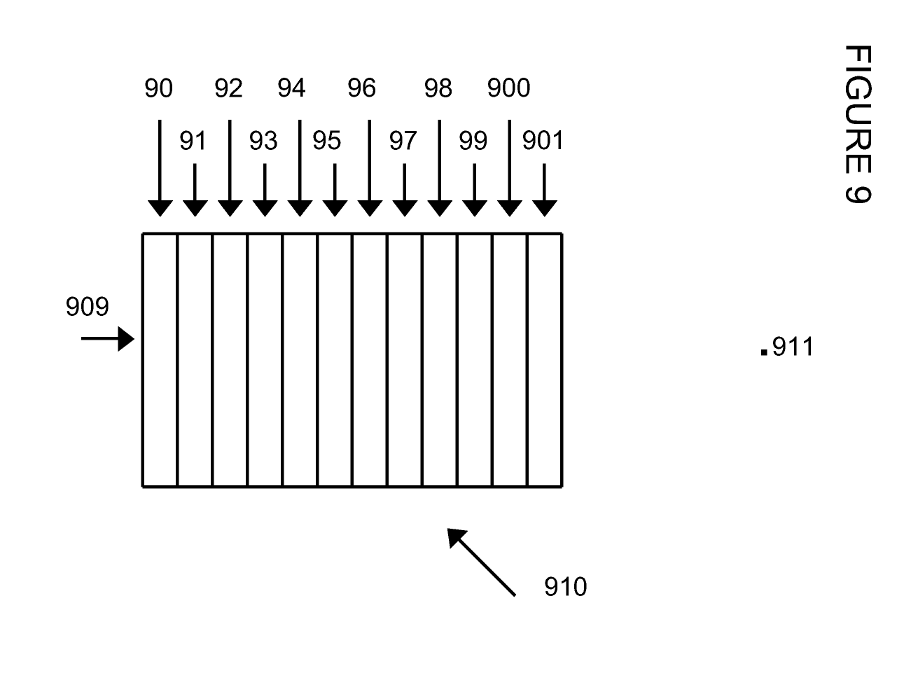

An example of a device structure which may be fabricated using the above procedures, or similar procedures, is given in FIG. 9. In use, the device structure 910 in FIG. 9 is illuminated by sufficiently coherent polarized visible radiation from the face 909 so that a viewer at point 911, which is not shown at a distance from the device which is to scale with respect to the device, may view a three dimensional image. The layers in the device from 90 through to 901 are not necessarily to scale with respect to each other. Layer 90 is a substrate layer, such as a glass layer. Layer 91 is a CIAD layer, which may be omitted in some implementations. Layer 92 is an insulating layer. Layer 93 is a magneto optical film layer. Layer 94 is a micro-coil array layer. Layer 95 is a polarizing layer or set of layers. Layer 96 is an optional layer for giving desired separation between the two micro-coil arrays. Layer 97 is a further magneto optical film layer. Layer 98 is a further micro-coil array layer. Layer 99 is a further polarizing layer or set of layers. Layer 900 is a beam steering element array layer. Layer 901 is a plane of covering material, such as glass. In manufacture, the device 910 may be fabricated by starting with substrate layer 90 and depositing each layer in turn until the final layer 901 is added. Such a procedure has the advantage of facilitating that the layers of the structure may be aligned in fabrication to high accuracy. Alternatively, the layers may be fabricated in two or more parts and bonded together with a sufficient degree of alignment.

For the fabrication of devices according to the implementations, it is very important that unwanted birefringence, such as unwanted stress-induced birefringence, be kept to a minimum. Stress-induced birefringence causes linear or circular polarization states of light to change into elliptical polarization states of light. The presence of elliptical polarization states of light in the device where ideally linear or circular polarization states of light would be present will reduce contrast and colour fidelity, and will therefore degrade device performance.

While the implementations disclosed herein have emphasized the successive encoding of amplitude and phase in the MOSLM, it will be appreciated by those skilled in the art that any successive weighted encoding of two non-identical combinations of amplitude and phase, that is two combinations which are not related by being equal through multiplication by any real number, but not by any complex number (excluding the real numbers), may be used in principle to encode a hologram pixel. The reason is that the vector space of the possible holographic encodings of a pixel is spanned in the vector space sense by any two non-identical combinations of amplitude and phase, that is any two combinations which are not related by being equal through multiplication by any real number, but not by any complex number (excluding the real numbers).

In the Figures herein, the relative dimensions shown are not necessarily to scale.

Various modifications and alterations of the implementations will become apparent to those skilled in the art without departing from the scope of the implementations, and it should be understood that the implementations are not to be unduly limited to the illustrative examples and implementations set forth herein.

### APPENDIX I

### Technical Primer

The following section is meant as a primer to several key techniques used in some of the systems that implement the present implementations.

In conventional holography, the observer can see a holographic reconstruction of an object (which could be a changing scene); his distance from the hologram is not however relevant. The reconstruction is, in one typical optical arrangement, at or near the image plane of the light source illuminating the hologram and hence is at the Fourier plane of the hologram. Therefore, the reconstruction has the same far-field light distribution of the real world object that is reconstructed.

One early system (described in WO 2004/044659 and US 2006/0055994) defines a very different arrangement in which the reconstructed object is not at or near the Fourier plane of the hologram at all. Instead, a virtual observer window zone is at the Fourier plane of the hologram; the observer positions his eyes at this location and only then can a correct reconstruction be seen. The hologram is encoded on a LCD (or other kind of spatial light modulator) and illuminated so that the virtual observer window becomes the Fourier transform of the hologram (hence it is a Fourier transform that is imaged directly onto the eyes); the reconstructed object is then the Fresnel transform of the hologram since it is not in the focus plane of the lens. It is instead defined by a near-field light distribution (modelled using spherical wavefronts, as opposed to the planar wavefronts of a far field distribution). This reconstruction can appear anywhere between the virtual observer window (which is, as noted above, in the Fourier plane of the hologram) and the LCD or even behind the LCD as a virtual object.

There are several consequences to this approach. First, the fundamental limitation facing designers of holographic video systems is the pixel pitch of the LCD (or other kind of light modulator). The goal is to enable large holographic reconstructions using LCDs with pixel pitches that are commercially available at reasonable cost. But in the past this has been impossible for the following reason. The periodicity interval between adjacent diffraction orders in the Fourier plane is given by λD/p, where λ is the wavelength of the illuminating light, D is the distance from the hologram to the Fourier plane and p is the pixel pitch of the LCD. But in conventional holographic displays, the reconstructed object is in the Fourier plane. Hence, a reconstructed object has to be kept smaller than the periodicity interval; if it were larger, then its edges would blur into a reconstruction from an adjacent diffraction order. This leads to very small reconstructed objects—typically just a few cm across, even with costly, specialised small pitch displays. But with the present approach, the virtual observer window (which is, as noted above, positioned to be in the Fourier plane of the hologram) need only be as large as the eye pupil. As a consequence, even LCDs with a moderate pitch size can be used. And because the reconstructed object can entirely fill the frustum between the virtual observer window and the hologram, it can be very large indeed, i.e. much larger than the periodicity interval.

There is another advantage as well, deployed in one variant. When computing a hologram, one starts with one's knowledge of the reconstructed object—e.g. you might have a 3D image file of a racing car. That file will describe how the object should be seen from a number of different viewing positions. In conventional holography, the hologram needed to generate a reconstruction of the racing car is derived directly from the 3D image file in a computationally intensive process. But the virtual observer window approach enables a different and more computationally efficient technique. Starting with one plane of the reconstructed object, we can compute the virtual observer window as this is the Fresnel transform of the object. We then perform this for all object planes, summing the results to produce a cumulative Fresnel transform; this defines the wave field across the virtual observer window. We then compute the hologram as the Fourier transform of this virtual observer window. As the virtual observer window contains all the information of the object, only the single-plane virtual observer window has to be transformed to the hologram and not the multi-plane object. This is particularly advantageous if there is not a single transformation step from the virtual observer window to the hologram but an iterative transformation like the Iterative Fourier Transformation Algorithm. Each iteration step comprises only a single Fourier transformation of the virtual observer window instead of one for each object plane, resulting in significantly reduced computation effort.

Another interesting consequence of the virtual observer window approach is that all the information needed to reconstruct a given object point is contained within a relatively small section of the hologram; this contrasts with conventional holograms in which information to reconstruct a given object point is distributed across the entire hologram. Because we need encode information into a substantially smaller section of the hologram, that means that the amount of information we need to process and encode is far lower than for a conventional hologram. That in turn means that conventional computational devices (e.g. a conventional DSP with cost and performance suitable for a mass market device) can be used even for real time video holography.

There are some less than desirable consequences however. First, the viewing distance from the hologram is important—the hologram is encoded and illuminated in such a way that only when the eyes are positioned at the Fourier plane of the hologram is the correct reconstruction seen; whereas in normal holograms, the viewing distance is not important. There are however various techniques for reducing this Z sensitivity or designing around it.

Also, because the hologram is encoded and illuminated in such a way that correct holographic reconstructions can only be seen from a precise and small viewing position (i.e. precisely defined Z, as noted above, but also X and Y co-ordinates), eye tracking may be needed. As with Z sensitivity, various techniques for reducing the X,Y sensitivity or designing around it exist. For example, as pixel pitch decreases (as it will with LCD manufacturing advances), the virtual observer window size will increase. Furthermore, more efficient encoding techniques (like Kinoform encoding) facilitate the use of a larger part of the periodicity interval as virtual observer window and hence the increase of the virtual observer window.

The above description has assumed that we are dealing with Fourier holograms. The virtual observer window is in the Fourier plane of the hologram, i.e. in the image plane of the light source. As an advantage, the undiffracted light is focused in the so-called DC-spot. The technique can also be used for Fresnel holograms where the virtual observer window is not in the image plane of the light source. However, care must be taken that the undiffracted light is not visible as a disturbing background. Another point to note is that the term transform should be construed to include any mathematical or computational technique that is equivalent to or approximates to a transform that describes the propagation of light. Transforms are merely approximations to physical processes more accurately defined by Maxwellian wave propagation equations; Fresnel and Fourier transforms are second order approximations, but have the advantages that (a) because they are algebraic as opposed to differential, they can be handled in a computationally efficient manner and (ii) can be accurately implemented in optical systems.

Further details are given in US patent application 2006-0138711, US 2006-0139710 and US 2006-0250671, the contents of which are incorporated by reference.

### APPENDIX II

### Glossary of Terms Used in the Description

### Computer Generated Hologram

A computer generated video hologram CGH according to the implementations is a hologram that is calculated from a scene. The CGH may comprise complex-valued numbers representing the amplitude and phase of light waves that are needed to reconstruct the scene. The CGH may be calculated e.g. by coherent ray tracing, by simulating the interference between the scene and a reference wave, or by Fourier or Fresnel transform.

### Encoding

Encoding is the procedure in which a spatial light modulator (e.g. its constituent cells) are supplied with control values of the video hologram. In general, a hologram comprises of complex-valued numbers representing amplitude and phase.

### Encoded Area

The encoded area is typically a spatially limited area of the video hologram where the hologram information of a single scene point is encoded. The spatial limitation may either be realized by an abrupt truncation or by a smooth transition achieved by Fourier transform of an virtual observer window to the video hologram.

### Fourier Transform

The Fourier transform is used to calculate the propagation of light in the far field of the spatial light modulator. The wave front is described by plane waves.

### Fourier Plane

The Fourier plane contains the Fourier transform of the light distribution at the spatial light modulator. Without any focusing lens the Fourier plane is at infinity. The Fourier plane is equal to the plane containing the image of the light source if a focusing lens is in the light path close to the spatial light modulator.

### Fresnel Transform

The Fresnel transform is used to calculate the propagation of light in the near field of the spatial light modulator. The wave front is described by spherical waves. The phase factor of the light wave comprises a term that depends quadratically on the lateral coordinate.

### Frustum

A virtual frustum is constructed between an virtual observer window and the SLM and is extended behind the SLM. The scene is reconstructed inside this frustum. The size of the reconstructed scene is limited by this frustum and not by the periodicity interval of the SLM.

### Imaging Optics

Imaging optics are one or more optical components such as a lens, a lenticular array, or a microlens array used to form an image of a light source (or light sources). References herein to an absence of imaging optics imply that no imaging optics are used to form an image of the one or two SLMs as described herein at a plane situated between the Fourier plane and the one or two SLMs, in constructing the holographic reconstruction.

### Light System

The light system may include either of a coherent light source like a laser or a partially coherent light source like a LED. The temporal and spatial coherence of the partially coherent light source has to be sufficient to facilitate a good scene reconstruction, i.e. the spectral line width and the lateral extension of the emitting surface have to be sufficiently small.

### Microlens Array

A micro-lens array provides localised coherence over a small region of the display, that region being the only part of the display that encodes information used in reconstructing a given point of the reconstructed object. Localised coherence is typically within one micro-lens of the array. A sub-hologram, i.e. the encoded region, may be larger than a single micro-lens. The reconstructed point would then be an incoherent superposition of several reconstructions from different micro-lenses. Typically, the sub-hologram, i.e. the encoded region, extends over 1 or 2 micro-lenses.

### Virtual Observer Window (VOW)

The virtual observer window is a virtual window in the observer plane through which the reconstructed 3D object can be seen. The VOW is the Fourier transform of the hologram and is positioned within one periodicity interval in order to avoid that multiple reconstructions of the object being visible. The size of the VOW has to be at least the size of an eye pupil. The VOW may be much smaller than the lateral range of observer movement if at least one VOW is positioned at the observer's eyes with an observer tracking system. This facilitates the use of a SLM with moderate resolution and hence small periodicity interval. The VOW can be imagined as a keyhole through which the reconstructed 3D object can be seen, either one VOW for each eye or one VOW for both eyes together.

### Periodicity Interval

The CGH is sampled if it is displayed on a SLM composed of individually addressable cells. This sampling leads to a periodic repetition of the diffraction pattern. The periodicity interval is λD/p, where λ is the wavelength, D the distance from the hologram to the Fourier plane, and p the pitch of the SLM cells.

### Reconstruction

The illuminated spatial light modulator encoded with the hologram reconstructs the original light distribution. This light distribution was used to calculate the hologram. Ideally, the observer would not be able to distinguish the reconstructed light distribution from the original light distribution. In most holographic displays the light distribution of the scene is reconstructed. In our display, rather the light distribution in the virtual observer window is reconstructed.

### Scene

The scene that is to be reconstructed is a real or computer generated three-dimensional light distribution. As a special case, it may also be a two-dimensional light distribution. A scene can constitute different fixed or moving objects arranged in a space.

### Spatial Light Modulator (SLM)

A SLM is used to modulate the wave front of the incoming light. An ideal SLM would be capable of representing arbitrary complex-valued numbers, i.e. of separately controlling the amplitude and the phase of a light wave. However, a typical conventional SLM controls only one property, either amplitude or phase, with the undesirable side effect of also affecting the other property.

1. A holographic display device comprising at least one magneto-optical spatial light modulator (MOSLM).

2. Holographic display device of claim 1 comprising a first MOSLM and a second MOSLM, the first and second MOSLMs encoding a hologram and a holographic reconstruction being generated by the device.

3. Holographic display device of claim 2, in which the first MOSLM and the second MOSLM modulate amplitudes and phases of an array of hologram pixels in a controlled independent manner.

4. Holographic display device of claim 2 comprising a compact combination of the first MOSLM and the second MOSLM which is used to modulate the amplitude and the phase of light in sequence and in a compact way such that a complex number, which consists of an amplitude and a phase, is encoded in the transmitted light, on a pixel by pixel basis.

5. Holographic display device of claim 1 comprising a compact combination of an MOSLM and a compact light source of sufficient coherence, the combination being capable of generating a three dimensional image under suitable illumination conditions.

6. Holographic display device of claim 1 comprising a large magnification three dimensional image display device component incorporating a compact combination of one or two MOSTMs1 with holographic reconstruction of the object.

7. Holographic display device of claim 1, which incorporates a compact combination of one or two MOSLMs and which may also be used as a projector.

8. (canceled)

9. Holographic display device of claim 1 in which the device modulates light using the Faraday effect.

10. Holographic display device of claim 9, where the Faraday effect is realized using a magneto-photonic crystal or where the Faraday effect is realized using doped glass fibers or where the Faraday effect is realized using a magneto-optical film.

11-12. (canceled)

13. Holographic display device of claim 1, in which holographic reconstruction is visible through a virtual observer window.

14. Holographic display device of claim 13, in which virtual observer windows can be tiled using spatial or time multiplexing.

15. Holographic display device of claim 1, in which the display is operable to time sequentially re-encode a hologram on the hologram-bearing medium for the left and then the right eye of at least one observer.

16. (canceled)

17. Holographic display device of claim 1, in which the display has an element for beam steering, or a beamsplitter.

18. Holographic display device of claim 1, in which the display has a CIAD layer.

19-20. (canceled)

21. Holographic display device of claim 1, in which the device is a television or a monitor or in which the device is portable.

22-23. (canceled)

24. Method of manufacturing a holographic display device, including the steps of taking a glass substrate and successively printing or otherwise creating the layers for an MOSLM on the substrate.

25. A method of generating a holographic reconstruction comprising the step of using the display device of claim 1.

26. Holographic display device of claim 1 in which a beam steering element is present for tracking virtual observer windows (VOWs), the beam steering element comprising of controllable prism arrays with prism elements, the prism array especially being in the form of an electro-wetting prism array, a prism element comprising electrodes and a cavity filled with two separate liquids and an interface between the liquids, the slope of the interface between the liquids being electrically controllable by applying voltage to the electrodes.
